(19) United States
(12) Patent Application Publication
(10) Pub. No.: US 2017/0198149 A1
(43) Pub. Date: Jul. 13, 2017

(54) WAVELENGTH CONVERSION MEMBER, BACKLIGHT UNIT, LIQUID CRYSTAL DISPLAY DEVICE, QUANTUM DOT-CONTAINING POLYMERIZABLE COMPOSITION, AND MANUFACTURING METHOD OF WAVELENGTH CONVERSION MEMBER

(71) Applicant: FUJIFILM Corporation, Tokyo (JP)

(72) Inventors: Naoyoshi YAMADA, Kanagawa (JP); Tatsuya OBA, Kanagawa (JP); Hirofumi TOYAMA, Kanagawa (JP); Natsuru CHIKUSHI, Kanagawa (JP)

(73) Assignee: FUJIFILM Corporation, Tokyo (JP)

(21) Appl. No.: 15/471,569

(22) Filed: Mar. 28, 2017

Related U.S. Application Data
(63) Continuation of application No. PCT/JP2015/077756, filed on Sep. 30, 2015.

(30) Foreign Application Priority Data
Sep. 30, 2014 (JP) 2014-202541
Feb. 3, 2015 (JP) 2015-019745
Jun. 10, 2015 (JP) 2015-117777

(51) Int. Cl. C09D 4/00; F21V 9/16; B32B 27/20; C09D 5/24; B32B 37/10; B32B 38/00; C09K 11/02; C09D 5/22; G02F 1/1335; B32B 27/30

(52) U.S. Cl. CPC C09D 4/00; G02F 1/1336; F21V 9/16; B32B 27/20; B32B 27/308; B32B 37/10; B32B 38/164; C09K 11/025; C09D 5/22; C09D 5/24; G02F 2001/133614; G02F 2202/36; B32B 2307/422; B32B 2457/202; C08K 2201/001; C08K 2201/011; C08K 3/32

(57) ABSTRACT

The wavelength conversion member includes a wavelength conversion layer containing a quantum dot, in which the wavelength conversion layer is a cured layer formed by curing a polymerizable composition containing the quantum dot and a polymerizable compound, the polymerizable composition contains at least one type of first polymerizable compound, the first polymerizable compound is a monofunctional (meth)acrylate compound in which a value of Mw/F obtained by dividing a molecular weight Mw by the number F of polymerizable functional groups in one molecule is greater than or equal to 130, the number of (meth)acryloyl groups in one molecule is 1, and a Log P value is less than or equal to 3.0, and the polymerizable composition contains greater than or equal to 50 parts by mass of the first polymerizable compound with respect to 100 parts by mass of the total amount of the polymerizable compound contained in the polymerizable composition.

### CROSS-REFERENCE TO RELATED APPLICATIONS

This application is a Continuation of PCT International Application No. PCT/JP2015/077756 filed on Sep. 30, 2015, which was published under PCT Article 21(2) in Japanese and claims priority under 35 U.S.C §119(a) to Japanese Patent Application No. 2014-202541 filed on Sep. 30, 2014, Japanese Patent Application No. 2015-019745 filed on Feb. 3, 2015, and Japanese Patent Application No. 2015-117777 filed on Jun. 10, 2015. The above applications are hereby expressly incorporated by reference, in their entirety, into the present application.

### BACKGROUND OF THE INVENTION

1. Field of the Invention

The present invention relates to a wavelength conversion member, a backlight unit, a liquid crystal display device, a quantum dot-containing polymerizable composition, and a manufacturing method of a wavelength conversion member.

2. Description of the Related Art

A flat panel display such as a liquid crystal display device (hereinafter, also referred to as a liquid crystal display (LCD)) has been widely used year by year as a space saving image display device having low power consumption. The liquid crystal display device is configured of at least a backlight unit and a liquid crystal cell, and in general, further includes a member such as a backlight side polarizing plate and a visible side polarizing plate.

In the flat panel display market, improvement in color reproducibility has progressed as improvement in LCD performance. Regarding this viewpoint, recently, a quantum dot (also referred to as QD) has received attention as a light emitting material (refer to US2012/0113672A1). For example, in a case where exciting light is incident on a wavelength conversion member containing a quantum dot from a backlight, the quantum dot is excited and emits fluorescent light. Here, by using quantum dots having different light emission properties, it is possible to realize white light by emitting each bright line light of red light, green light, and blue light. The fluorescent light of the quantum dot has a small half-width, and thus, white light to be obtained has high brightness and excellent color reproducibility. A color reproduction range increases from 72% to 100% of a national television system committee (NTSC) ratio according to progress in a three-wavelength light source technology using such a quantum dot.

### SUMMARY OF THE INVENTION

As described above, one of advantages of the wavelength conversion member containing a quantum dot is that white light having a high brightness can be obtained.

However, as a result of studies of the present inventors, it has been found that there is a case where the following phenomena occur in a liquid crystal display device including a wavelength conversion member containing a quantum dot:

(1) a decrease in a brightness of exiting light which exits from a backlight unit (a decrease in a backlight brightness), and

(2) display unevenness on a display surface (tint unevenness or brightness unevenness). The phenomena (1) and (2) cause a decrease in image quality which is displayed on the display surface of the liquid crystal display device, and thus, are required to be improved.

Therefore, an object of the present invention is to provide novel means for suppressing a decrease in a backlight brightness and display unevenness on a display surface in a liquid crystal display device including a wavelength conversion member containing a quantum dot.

An aspect of the present invention relates to a wavelength conversion member, comprising: a wavelength conversion layer containing a quantum dot which is excited by exciting light and emits fluorescent light, in which the wavelength conversion layer is a cured layer formed by curing a polymerizable composition containing the quantum dot and a polymerizable compound, the polymerizable composition contains at least one type of first polymerizable compound, the first polymerizable compound is a monofunctional (meth)acrylate compound in which a value of Mw/F obtained by dividing a molecular weight Mw by the number F of polymerizable functional groups in one molecule is greater than or equal to 130, the number of (meth)acryloyl groups in one molecule is 1, and a Log P value is less than or equal to 3.0, and the polymerizable composition contains greater than or equal to 50 parts by mass of the first polymerizable compound with respect to 100 parts by mass of the total amount of the polymerizable compound contained in the polymerizable composition.

In the present invention and in this specification, the (meth)acrylate compound or (meth)acrylate indicates a compound having one or more (meth)acryloyl groups in one molecule, and the (meth)acryloyl group is used for indicating one or both of an acryloyl group and a methacryloyl group. In addition, a monofunctional (meth)acrylate compound indicates that the number of (meth)acryloyl groups in one molecule is one, and a polyfunctional (meth)acrylate compound indicates that the number of (meth)acryloyl groups in one molecule is greater than or equal to 2.

In one aspect, the wavelength conversion member further comprises a base material, and at least one main surface of the wavelength conversion layer is in contact with the base material. Here, the “main surface” indicates a surface (a front surface or a back surface) of the wavelength conversion layer disposed on a visible side or a backlight side at the time of using the wavelength conversion member. The same applies to main surfaces of other layers or other members.

In one aspect, the wavelength conversion member further comprises a first base material and a second base material, the wavelength conversion layer is in contact with the first base material on one main surface, and is in contact with the second base material on the other main surface, and both of the first base material and the second base material have an oxygen permeability of less than or equal to 1.00 cm³/m²/day/atm. Here, “being in contact with something” indicates that being directly in contact with something without other layers. The same applies to “adjacent” described below. Furthermore, the unit of the oxygen permeability of “cm³/m²/day/atm” can also be represented by “cm³/(m²·day·atm)”, and both of the units are identical to each other.

In one aspect, the polymerizable composition contains at least one type of other polymerizable compound along with the first polymerizable compound.

In one aspect, the other polymerizable compound contains a second polymerizable compound in which the number of polymerizable functional groups in one molecule is greater than or equal to 2.

In one aspect, the second polymerizable compound is a polymerizable compound containing two or more polymerizable functional groups selected from the group consisting of a (meth)acryloyl group, a vinyl group, an epoxy group, and an oxetanyl group in one molecule.

In one aspect, the quantum dot-containing polymerizable composition further contains a viscosity adjuster.

In one aspect, the quantum dot is at least one type selected from the group consisting of a quantum dot having a light emission center wavelength in a wavelength range of 600 nm to 680 nm, a quantum dot having a light emission center wavelength in a wavelength range of 520 nm to 560 nm, and a quantum dot having a light emission center wavelength in a wavelength range of 430 nm to 480 nm.

Another aspect of the present invention relates to a backlight unit, comprising at least: the wavelength conversion member described above; and a blue light source or an ultraviolet light source.

Still another aspect of the present invention relates to a liquid crystal display device, comprising at least: the backlight unit described above; and a liquid crystal cell.

Even still another aspect of the present invention relates to a quantum dot-containing polymerizable composition.

Further still another aspect of the present invention relates to a manufacturing method of a wavelength conversion member including a wavelength conversion layer containing a quantum dot which is excited by exciting light and emits fluorescent light, the wavelength conversion layer being a cured layer formed by curing a polymerizable composition containing the quantum dot and a polymerizable compound, the method comprising: forming the cured layer by curing the quantum dot-containing polymerizable composition described above.

According to the present invention, it is possible to provide a wavelength conversion member containing a quantum dot capable of providing a liquid crystal display device in which a decrease in a backlight brightness and occurrence of display unevenness are suppressed, and to provide a backlight unit and a liquid crystal display device including the wavelength conversion member.

Further, according to the present invention, it is also possible to provide a quantum dot-containing polymerizable composition capable of manufacturing the wavelength conversion member, and to provide a manufacturing method of a wavelength conversion member using the quantum dot-containing polymerizable composition.

### BRIEF DESCRIPTION OF THE DRAWINGS

FIG. 1A and FIG. 1B are explanatory diagrams of an example of a backlight unit including a wavelength conversion member.

FIG. 2 is a schematic configuration diagram of an example of a manufacturing device of a wavelength conversion member.

FIG. 3 is a partially enlarged view of the manufacturing device illustrated in FIG. 2.

FIG. 4 illustrates an example of a liquid crystal display device.

### DESCRIPTION OF THE PREFERRED EMBODIMENTS

The following description is based on representative embodiments of the present invention, but the present invention is not limited to such embodiments. Furthermore, in the present invention and in this specification, a numerical range represented by using “to” indicates a range including numerical values before and after “to” as the lower limit value and the upper limit value.

In the present invention and in this specification, a “half-width” of a peak indicates the width of a peak at a height of ½ of a peak height. In addition, light having a light emission center wavelength in a wavelength range of 430 to 480 nm will be referred to as blue light, light having a light emission center wavelength in a wavelength range of 520 to 560 nm will be referred to as green light, and light having a light emission center wavelength in a wavelength range of 600 to 680 nm will be referred to as red light.

In addition, in the present invention and in this specification, a “polymerizable composition” is a composition containing at least one type of polymerizable compound, and has properties of being cured by a polymerization treatment such as light irradiation and heating. In addition, the “polymerizable compound” is a compound having one or more polymerizable functional groups in one molecule. The polymerizable functional group is a group which can be involved in a polymerization reaction, and the details thereof will be described below.

[Wavelength Conversion Member]

A wavelength conversion member of the present invention relates to a wavelength conversion member including a wavelength conversion layer containing a quantum dot which is excited by exciting light and emits fluorescent light, in which the wavelength conversion layer is a cured layer formed by curing a polymerizable composition containing the quantum dot and a polymerizable compound, the polymerizable composition contains at least one type of first polymerizable compound, the first polymerizable compound is a monofunctional (meth)acrylate compound in which a value of Mw/F obtained by dividing a molecular weight Mw by the number F of polymerizable functional groups in one molecule is greater than or equal to 130, the number of (meth)acryloyl groups in one molecule is 1, and a Log P value is less than or equal to 3.0, and the polymerizable composition contains greater than or equal to 50 parts by mass of the first polymerizable compound with respect to 100 parts by mass of the total amount of the polymerizable compound contained in the polymerizable composition.

As a result of intensive studies of the present inventors for attaining the objects described above, the wavelength conversion member of the present invention has been found. Hereinafter, this will be further described.

It is considered that a reason for the phenomenon (1) described above, that is, the decrease in the backlight brightness is that in a ease where a quantum dot is in contact with oxygen molecules, a light emission efficiency is decreased by a photooxidation reaction. Regarding this, in US2012/0113672A1, it is proposed that a barrier layer is laminated on a film containing a quantum dot (a wavelength conversion layer) in order to protect the quantum dot from the oxygen molecules or the like. However, when the wavelength conversion member is processed into a product, the wavelength conversion member is cut out from a sheet-like wavelength conversion member raw material to have a product size (for example, punched by a punching machine). In the product cut out as described above, the barrier layer does not exist on an end surface, and thus, it is concerned that oxygen molecules enter from the end surface, and thus, the light emission efficiency of the quantum dot decreases, and for example, in an exiting surface outer circumferential region of the backlight unit, a brightness decreases. Regarding this, the present inventors have concluded that it is preferable to decrease the permeability of the oxygen molecules (the oxygen permeability) of the wavelength conversion layer itself in order to suppress the decrease in the backlight brightness which is considered to occur due to the contact between the quantum dot and the oxygen molecules.

Further, in intensive studies of the present inventors, it is considered that a reason for the phenomenon (2) described above, that is the display unevenness on the display surface may be that the wavelength conversion layer and the wavelength conversion member including a wavelength conversion layer are deformed by polymerization contraction. The details thereof are as described below. In general, the wavelength conversion layer containing a quantum dot contains the quantum dot in a matrix. Such a wavelength conversion layer can be formed as the cured layer by curing the polymerizable composition containing the quantum dot and the polymerizable compound. More specifically, the polymerizable composition is cured by the polymerization treatment, and thus, the wavelength conversion layer can be formed. However, it is considered that the polymerization contraction occurring in the polymerization treatment causes the deformation of the wavelength conversion layer and the wavelength conversion member including the wavelength conversion layer. Then, the present inventors have concluded that the deformation causes a local difference in the light extraction efficiency from the wavelength conversion member, and thus, the display unevenness on the display surface may occur. On the other hand, the present inventors have considered that the (meth)acrylate compound is preferable as the polymerizable compound on the basis of various viewpoints of curing properties, easy availability, and the like. Therefore, regarding the phenomenon (2), the present inventors have conducted intensive studies in order to find a composition which is a polymerizable composition containing a (meth)acrylate compound as a polymerizable compound, and rarely causes the polymerization contraction (or decrease the polymerization contraction).

The wavelength conversion member of the present invention which had been found as a result of intensive studies of the present inventors as described above can suppress the decrease in the backlight brightness and the occurrence of the display unevenness on the display surface. The present inventors have assumed the following points contribute to the effects described above.

(1) Setting the proportion of the monofunctional (meth)acrylate compound in the polymerizable composition for forming the wavelength conversion layer to be greater than or equal to 50 parts by mass with respect to 100 parts by mass of the total amount of the polymerizable compound. This is because it is considered that the monofunctional (meth)acrylate compound rarely causes the polymerization contraction (or decreases the polymerization contraction), compared to a polyfunctional (meth)acrylate compound.

(2) Considering that in the monofunctional (meth)acrylate compound, a monofunctional (meth)acrylate compound having Mw/F of greater than or equal to 130 rarely causes the polymerization contraction (or decreases the polymerization contraction).

(3) Considering that a compound having Log P of less than or equal to 3.0 indicates a compound having a high polarity compared to oxygen molecules which are non-polarity molecules, and a wavelength conversion layer formed of a polymerizable composition containing the compound in a large amount is lack of compatibility with respect to oxygen molecules, and thus, the oxygen molecules rarely enter.

Here, the points described above are assumptions of the present inventors, and the present invention is not limited thereto.

Hereinafter, the wavelength conversion member of the present invention will be described in more detail.

(Configuration and Arrangement Example of Wavelength Conversion Member)

The wavelength conversion member may have a function of converting at least a part of a wavelength of an incidence ray and of allowing light having a wavelength different from the wavelength of the incidence ray to exit. The shape of the wavelength conversion member is not particularly limited, and can have an arbitrary shape such as a sheet and a bar. The wavelength conversion member can be used as a constituent of a backlight unit of a liquid crystal display device.

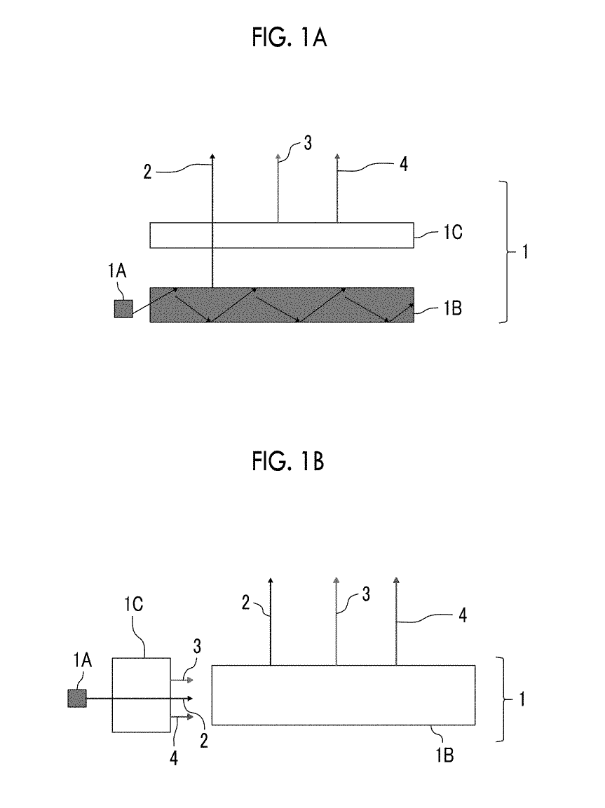

FIGS. 1A and 1B are explanatory diagrams of an example of a backlight unit 1 including the wavelength conversion member. In FIGS. 1A and 1B, the backlight unit 1 includes a light source 1A, and a light guide plate 1B for being used as a plane light source. In the example illustrated in FIG. 1A, the wavelength conversion member is disposed on a path of light exiting from the light guide plate. On the other hand, in the example illustrated in FIG. 1B, the wavelength conversion member is disposed between the light guide plate and the light source. Then, in the example illustrated in FIG. 1A, light exiting from the light guide plate 1B is incident on a wavelength conversion member 1C.

In the example illustrated in FIG. 1A, light 2 exiting from the light source 1A disposed on an edge portion of the light guide plate 1B is blue light, and exits towards a liquid crystal cell (not illustrated) from the surface of the light guide plate 1B on the liquid crystal cell side. The wavelength conversion member 1C disposed on a path of the light (the blue light 2) exiting from the light guide plate 1B includes at least a quantum dot (A) which is excited by the blue light 2 and emits red light 4, and a quantum dot (B) which is excited by the blue light 2 and emits green light 3. Thus, the green light 3 and the red light 4 which are excited, and the blue light 2 which is transmitted through the wavelength conversion member 1C exit from the backlight unit 1. Thus, the red light, the green light, and the blue light are emitted, and thus, white light can be realized.

The example illustrated in FIG. 1B is identical to the aspect illustrated in FIG. 1A except that the arrangement of the wavelength conversion member and the light guide plate is different. In the example illustrated in FIG. 1B, the green light 3 and the red light 4 which are excited, and the blue light 2 which is transmitted through the wavelength conversion member 1C exit from the wavelength conversion member 1C and are incident on the light guide plate, and thus, a plane light source is realized.

(Wavelength Conversion Layer)

The wavelength conversion member includes at least the wavelength conversion layer containing a quantum dot. The wavelength conversion layer contains the quantum dot in a matrix. The matrix contains a polymer, the wavelength conversion layer can be formed of a quantum dot-containing polymerizable composition containing a quantum dot and a polymerizable compound, and the wavelength conversion layer may be a cured layer formed by curing the quantum dot-containing polymerizable composition. The shape of the wavelength conversion layer is not particularly limited, and can have an arbitrary shape such as a sheet and a bar.

The quantum dot is excited by exciting light and emits fluorescent light. The wavelength conversion layer contains at least one type of quantum dot, and can contain two or more types of quantum dots having different light emission properties. A known quantum dot includes a quantum dot (A) having a light emission center wavelength in a wavelength range of 600 nm to 680 nm, a quantum dot (B) having a light emission center wavelength in a wavelength range of 520 nm to 560 nm, and a quantum dot (C) having a light emission center wavelength in a wavelength range of 400 nm to 500 nm. The quantum dot (A) is excited by exciting light and emits red light, the quantum dot (B) emits green light, and the quantum dot (C) emits blue light. For example, in a case where blue light is incident on a wavelength conversion layer containing the quantum dot (A) and the quantum dot (B) as the exciting light, as illustrated in FIGS. 1A and 1B, white light can be realized by the red light emitted from the quantum dot (A) and the green light emitted from the quantum dot (B), and the blue light transmitted through the wavelength conversion layer. Alternatively, ultraviolet light is incident on a wavelength conversion layer containing the quantum dots (A), (B), and (C) as the exciting light, and thus, white light can be realized by the red light emitted from the quantum dot (A), the green light emitted from the quantum dot (B), and the blue light emitted from the quantum dot (C).

(Quantum Dot-Containing Polymerizable Composition)

The wavelength conversion layer is the cured layer formed by curing the quantum dot-containing polymerizable composition. The quantum dot-containing polymerizable composition (also referred to as a “polymerizable composition”) contains a quantum dot and at least one type of first polymerizable compound. The quantum dot-containing polymerizable composition may contain other components such as a polymerization initiator, a viscosity adjuster, and an organic metal coupling agent.

(Quantum Dot)

The quantum dot, for example, can be referred to paragraphs 0060 to 0066 of JP2012-169271A in addition to the above description, but is not limited thereto. A commercially available product can be used as the quantum dot without any limitation. A light emission wavelength of the quantum dot, in general, can be adjusted according to the composition of the particles, the size of the particles, and the composition and the size of the particles.

The quantum dot may be added to the polymerizable composition described above in a state of particles, or may be added in a state of a dispersion liquid in which the quantum dots are dispersed in a solvent. It is preferable that the quantum dot is added in the state of the dispersion liquid from the viewpoint of suppressing aggregation of the particles of the quantum dot. Here, the solvent to be used is not particularly limited. The quantum dot can be added, for example, in the amount of approximately 0.01 to 10 parts by mass with respect to 100 parts by mass of the total amount of the polymerizable composition.

(First Polymerizable Compound)

The first polymerizable compound is the monofunctional (meth)acrylate compound in which the value of Mw/F obtained by dividing the molecular weight Mw by the number F of polymerizable functional groups in one molecule is greater than or equal to 130, the number of (meth)acryloyl groups in one molecule is 1, and the Log P value is less than or equal to 3.0. Only one type of compound may be used, or two or more types of compounds having different structures may be used, as the first polymerizable compound. In a case where two or more types of compounds having different structures are used as the first polymerizable compound, each of the compounds is the monofunctional (meth)acrylate compound in which Mw/F is greater than or equal to 130, the number of (meth)acryloyl groups in one molecule is 1, and the Log P value is less than or equal to 3.0.

In the first polymerizable compound, the value of Mw/F obtained by dividing the molecular weight Mw by the number F of polymerizable functional groups in one molecule is greater than or equal to 130. It is preferable that Mw/F is greater than or equal to 150. As described above, that the monofunctional (meth)acrylate compound having Mw/F of greater than or equal to 130 is considered to rarely cause the polymerization contraction (or decreases the polymerization contraction), and the present inventors have assumed that this contributes to a decrease in the display unevenness described above. It is preferable that Mw/F is less than or equal to 300, and Mw/F may be greater than 300. In a case where Mw/F is less than or equal to 300, the viscosity of the polymerizable composition containing the first polymerizable compound tends to decrease. This is preferable since the wavelength conversion layer is easily formed by coating. As described above, the polymerizable functional group is the group which can be involved in the polymerization reaction, and is preferably a functional group which can cause a polymerization reaction by a radical polymerization or a cationic polymerization. Specific examples of the polymerizable functional group can include a (meth)acryloyl group, a vinyl group, a glycidyl group, an oxetane group, an alicyclic epoxy group, and the like. Here, the alicyclic epoxy group indicates a monovalent functional group having a cyclic structure in which an epoxy ring and a saturated hydrocarbon ring are condensed.

The first polymerizable compound is the monofunctional (meth)acrylate compound, in which the number of (meth)acryloyl groups in one molecule is 1. The monofunctional (meth)acrylate compound is preferable since the monofunctional (meth)acrylate compound is easily cured by a polymerization treatment (for example, light irradiation), and can suppress contraction of a matrix at the time of performing curing. The first polymerizable compound may have a polymerizable functional group other than the (meth)acryloyl group in one molecule, in addition to one (meth)acryloyl group. Having the other polymerizable functional group along with the (meth)acryloyl group is preferable from the viewpoint of a high hardness of the wavelength conversion layer, and the like. In a case where the first polymerizable compound has the polymerizable functional group other than the (meth)acryloyl group, the number of such polymerizable functional groups in one molecule, for example, is greater than or equal to 1, and may be greater than or equal to 2 in a range where Mw/F is greater than or equal to 130.

Furthermore, in the present invention and in this specification, the molecular weight of the polymerizable compound indicates a weight-average molecular weight of a polymer (the polymer also includes an oligomer). The weight-average molecular weight indicates a weight-average molecular weight obtained by calculating a measured value from a gel permeation chromatography (GPC) in terms of polystyrene. For example, the following conditions can be adopted as measurement conditions of GPC. The weight-average molecular weight described in examples described below is a value measured according to the following conditions.

GPC Device: HLC-8120 (manufactured by TOSOH CORPORATION)

Column: TSK gel Multipore HXL-M (manufactured by TOSOH CORPORATION, 7.8 mmID (an inner diameter)×30.0 cm)

Eluant: Tetrahydrofuran

In addition, in the first polymerizable compound, the Log P value is less than or equal to 3.0. The Log P value is preferably less than or equal to 2.5, and is more preferably less than or equal to 2.0. The Log P value is preferably greater than or equal to 0.5, and may be less than 0.5. In a ease where the Log P value is greater than or equal to 0.5, it is preferable since the quantum dots tend to be easily dispersed in the polymerizable composition containing the first polymerizable compound.

The Log P value is an index of hydrophilicity, and indicates that a polarity is high as the value becomes small. On the other hand, the oxygen molecules are non-polarity molecules. It is considered that a compound having a Log P value of less than or equal to 3.0 has a high polarity compared to oxygen molecules, and thus, a wavelength conversion layer formed of a polymerizable composition which contains the compound in a large amount (specifically, contains greater than or equal to 50 parts by mass of the first polymerizable compound with respect to 100 parts by mass of the total amount of the polymerizable compound contained in the composition) is lack of the compatibility with respect to the oxygen molecules, and thus, the oxygen molecules rarely enter. The present inventors have assumed that this contributes to suppression of a decrease in the light emission efficiency of the quantum dot due to the entrance of the oxygen molecules from an end surface of the wavelength conversion layer after being cut out as described above or an interface end portion between the wavelength conversion layer and the adjacent layer.

In the present invention and in this specification, the Log P value indicates a logarithmic value of a partition coefficient of 1-octanol/water. The Log P value can be calculated by using a fragment method, an atomic approaching method, and the like. The Log P value described in this specification is a Log P value which is calculated from a structure of a compound by using ChemBioDraw Ultra12.0 manufactured by PerkinElmer, Inc.

Only one type of the monofunctional (meth)acrylate compound described above may be used, or two or more types thereof having different structures may be used, as the first polymerizable compound. In a case where two or more types of the monofunctional (meth)acrylate compounds are used, the content thereof described below indicates the total content of two or more types of the monofunctional (meth)acrylate compounds. The same applies to the content of other components described below.

The content of the first polymerizable compound is greater than or equal to 50 parts by mass, is preferably greater than or equal to 70 parts by mass, and is more preferably greater than or equal to 90 parts by mass, with respect to 100 parts by mass of the total amount of the polymerizable compound contained in the quantum dot-containing polymerizable composition. According to the polymerizable composition containing the first polymerizable compound at the content described above, it is possible to suppress the occurrence of the display unevenness described above. As described above, it is considered that this is because the polymerizable composition containing the first polymerizable compound at the content described above rarely causes the polymerization contraction (or decreases the polymerization contraction). The content described above, for example, may be less than 99 parts by mass, or may be less than or equal to 95 parts by mass, or the total of the polymerizable compound may be the first polymerizable compound. That is, the content described above may be 100 parts by mass.

In addition, the total content of the polymerizable compound with respect to 100 parts by mass of the polymerizable composition total amount, for example, can be set to approximately 80.00 to 99.99 mass %.

Examples of the monofunctional (meth)acrylate compound which can be used as the first polymerizable compound can include an acrylic acid and a methacrylic acid, and a derivative thereof, and more specifically, a monomer having one polymerizable unsaturated bond ((meth)acryloyl group) of a (meth)acrylic acid in the molecules. Specific examples thereof include compounds described below, but the present invention is not limited thereto. Specifically, n-butyl (meth)acrylate, isobutyl (meth)acrylate, benzyl (meth)acrylate, 2-phenoxy ethyl (meth)acrylate, 1,4-cyclohexane dimethanol monoacrylate, butoxy ethyl (meth)acrylate, N,N-dimethyl aminoethyl (meth)acrylate, cyclohexyl (meth)acrylate, 2-hydroxy ethyl (meth)acrylate, 2-hydroxy propyl (meth)acrylate, 4-hydroxy butyl (meth)acrylate, (meth)acrylate derivative having an adamantane skeleton, and the like. Furthermore, the (meth)acrylic acid described above indicates any one or both of an acrylic acid and a methacrylic acid.

(Polymerizable Compound Capable of Being Used Together with First Polymerizable Compound)

The quantum dot-containing polymerizable composition may contain only one or more types of first polymerizable compounds as the polymerizable compound, or may contain one or more types of other polymerizable compounds along with one or more types of the first polymerizable compounds. The other polymerizable compound may be a compound which does not correspond to the first polymerizable compound (the monofunctional (meth)acrylate compound in which Mw/F described above is greater than or equal to 130, the number of (meth)acryloyl groups in one molecule is 1, and the Log P value is less than or equal to 3.0), but has one or more polymerizable functional groups in one molecule.

A polyfunctional (meth)acrylate compound, a monofunctional (meth)acrylate compound which does not correspond to the first polymerizable compound, and one type or two or more types of various polymerizable compounds having a polymerizable functional group other than the (meth)acryloyl group can be used as the other polymerizable compound.

For example, greater than or equal to 1 part by mass of the other polymerizable compound can be used with respect to 100 parts by mass of the total amount of the polymerizable compound contained in the polymerizable composition, it is preferable that less than or equal to 40 parts by mass of the other polymerizable compound is used, and it is more preferable that less than or equal to 30 parts by mass of the other polymerizable compound is used.

A preferred aspect of the other polymerizable compound can include a multimer (the multimer indicates a compound having repeating units which are identical to each other or different from each other, and is used as the meaning including an oligomer and a polymer such as a dimer, a trimer, and a tetramer, and the same applies to the following). A weight-average molecular weight of such a multimer is preferably greater than or equal to 1,000, is more preferably greater than or equal to 2,000, and is even more preferably greater than or equal to 3,000, from the viewpoint of further suppressing the polymerization contraction. In addition, it is preferable that the weight-average molecular weight described above is less than or equal to 1,000,000 from the viewpoint of solubility with respect to the first polymerizable compound and coating suitability (the viscosity) of the polymerizable composition.

In addition, in a case where the polymerizable compound is a multimer, it is preferable to have one type or two or more types of a polarity group such as a hydroxyl group and a nitrile group, a chlorine atom, and a fluorine atom in the repeating unit. It is considered that the hydroxyl group, the nitrile group, and the like can contribute to a further decrease in the oxygen permeability of the wavelength conversion layer by a crosslinkable mutual interaction. In addition, it is considered that the chlorine atom and the fluorine atom, in general, are atoms having a large atomic radius among various atoms configuring an organic compound, and thus, fill up a gap in the structure of the polymer in which the polymerizable compound is polymerized, and therefore, can suppress the movement of the polymer. Accordingly, it is assumed that the oxygen permeability can be further suppressed.

(Preferred Structure of First Polymerizable Compound and Other Polymerizable Compound)

It is preferable that the polymerizable composition described above contains a polymerizable compound having a structure described below as at least one of the first polymerizable compound or the other polymerizable compound.

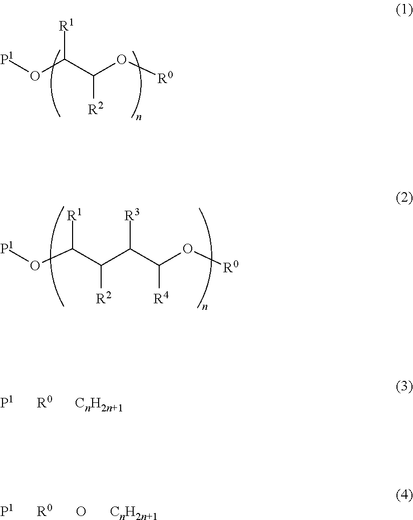

In (1) to (4) described above, n is an integer of greater than or equal to 1, P¹ is an arbitrary structure having at least one polymerizable functional group, and R⁰ is an arbitrary structure having a hydrogen atom or at least one non-covalent functional group. Here, the non-covalent functional group indicates a functional group which can exhibit a gravitational mutual interaction other than covalent bonding. Examples of the non-covalent functional group include a hydroxyl group, a urethane group, a urea group, a phenyl group, and the like. In (1) described above, at least one of R¹ or R² is a hydrogen atom, and the other is any one of a hydrogen atom, a hydroxyl group, and an alkyl group. Furthermore, in a case where n is an integer of greater than or equal to 2, at least one of a plurality of R¹'s or a plurality of R²'s is a hydrogen atom, and the other is any one of a hydrogen atom, a hydroxyl group, and an alkyl group.

In (2) described above, at least one of R¹ to R⁴ is a hydrogen atom, and the other is any one of a hydrogen atom, a hydroxyl group, and an alkyl group. Furthermore, in a case where n is an integer of greater than or equal to 2, at least one of a plurality of R¹'s, a plurality of R²'s, a plurality of R³'s, or a plurality of R⁴'s is a hydrogen atom, and the other is any one of a hydrogen atom, a hydroxyl group, and an alkyl group.

In the polymerizable compound having the structure described above, molecules tend to have flexibility compared to a polymerizable compound not having the structure described above. The present inventors have assumed that this contributes to improvement of the brittleness of the wavelength conversion layer. By improving the brittleness, it is possible to suppress the occurrence of a breakage or a crack in the end portion at the time of cutting out the wavelength conversion member to have a product size. Enabling the occurrence of such a breakage or a crack to be suppressed is preferable from the viewpoint of preventing the wavelength conversion layer from being peeled off from the adjacent layer.

In addition, the present inventors have considered that the polymerizable compound having the structure described above having a non-covalent functional group in the molecules contributes to a further decrease in the oxygen permeability of the wavelength conversion layer.

Specific examples of the polymerizable compound having the structure described above can include 2-phenoxy ethyl (meth)acrylate, 2-hydroxy propyl (meth)acrylate, and 4-hydroxy butyl (meth)acrylate. The examples are particularly preferable as the first polymerizable compound. Among them, 2-phenoxy ethyl (meth)acrylate is particularly preferable because of a profound effect of increasing adhesiveness between the wavelength conversion layer and the adjacent layer.

(Mwₐᵥₑ/Fₐᵥₑ and Log Pₐᵥₑ)

The quantum dot-containing polymerizable composition may contain only one type of polymerizable compound, or may contains two or more types of polymerizable compounds having different structures, as the polymerizable compound. That is, in a case where the number of types of the polymerizable compounds contained in the quantum dot-containing polymerizable composition is set to n in total, n is greater than or equal to 1, may be greater than or equal to 2, and for example, can be in a range of 3 to 5, or may be greater than or equal to 6, but is not particularly limited. In a total of n types of polymerizable compounds, it is preferable that a value of Mwₐᵥₑ/Fₐᵥₑ obtained by dividing Mwₐᵥₑ which is calculated from Expression 2 described below by Fₐᵥₑ which is calculated from Expression 1 described below is greater than or equal to 110.0. Mwₐᵥₑ/Fₐᵥₑ is more preferably greater than or equal to 130.0, and is even more preferably greater than or equal to 140.0. In a case where Mwₐᵥₑ/Fₐᵥₑ is in the range described above, it is preferable since the quantum dot-containing polymerizable composition more rarely causes the polymerization contraction (or further decreases the polymerization contraction), and thus, can further decrease the display unevenness. Furthermore, it is preferable that a barrier film which will be described below in detail is disposed to be adjacent to the wavelength conversion layer since the quantum dot contained in the wavelength conversion layer is further protected from the oxygen molecules or the like. Regarding this, it is preferable that the quantum dot-containing polymerizable composition rarely causes the polymerization contraction (or decreases the polymerization contraction) from the viewpoint of preventing the wavelength conversion layer from being partially peeled off from the barrier film in the end portion at the time of disposing the barrier film to be adjacent to the wavelength conversion layer. By preventing the wavelength conversion layer from being partially peeled off from the barrier film as described above, it is possible to further protect the quantum dot from the oxygen molecules or the like. Mwₐᵥₑ/Fₐᵥₑ, for example, is less than or equal to 300.0, or may be greater than 300.0.

$$\begin{matrix}Fave = \frac{\sum Fi \times Wi}{\sum Wi} & Expression 1 \\ Mwave = \frac{\sum Mwi \times Wi}{\sum {W}_{i}} & Expression 2\end{matrix}$$

In the expression described above, the n type of the polymerizable compounds described above are numbered in an arbitrary order, F is the number of polymerizable functional groups in one molecule of an i-th polymerizable compound, and Wᵢ is the mass of the i-th polymerizable compound contained in the polymerizable composition described above. In the mass, the same unit may be adopted with respect to all of the polymerizable compounds, and examples of the unit include “parts by mass”, “g”, and the like. The same applies to Expression 3 described below. Mwᵢ is a molecular weight of the i-th polymerizable compound, and i is an integer from 1 to n. That is, Fₐᵥₑ is a weight average of the number of polymerizable functional groups in one molecule of the polymerizable compound contained in the polymerizable composition described above, and Mwₐᵥₑ is a weight average of the molecular weight of the polymerizable compound contained in the polymerizable composition described above. Furthermore, the wavelength conversion layer formed by curing the polymerizable composition is analyzed by a known method (for example, nuclear magnetic resonance (NMR), various chromatography methods, and the like), and thus, the mass of the polymerizable compound contained in the polymerizable composition used for forming the layer, the number of polymerizable functional groups in one molecule, and the molecular weight can be obtained. For example, in a case where the quantum dot-containing polymerizable composition contains a total of three types of polymerizable compounds having different structures, and the compounds are set to a compound A, a compound B, and a compound C, Fₐᵥₑ and Mwₐᵥₑ are calculated as described below. In the below description, F_{A} is the number of polymerizable functional groups in one molecule of the compound A, W_{A} is the mass of the compound A contained in the quantum dot-containing polymerizable composition, and Mw_{A} is a molecular weight of the compound A. The same applies to F_{B}, F_{C}, W_{B}, W_{C}, Mw_{B}, and Mw_{C} of each of the compounds B and C.

$${F}_{ave} = \frac{{F}_{A} \times {W}_{A} + {F}_{B} \times {W}_{B} + {F}_{C} \times {W}_{C}}{{W}_{A} + {W}_{B} + {W}_{C}}$$

$${Mw}_{ave} = \frac{{Mw}_{A} \times {W}_{A} + {Mw}_{H} \times {W}_{H} + {Mw}_{C} \times {W}_{C}}{{W}_{A} + {W}_{B} + {W}_{C}}$$

In addition, in the n types of the polymerizable compounds described above, Log Pₐᵥₑ calculated from Expression 3 described below is preferably less than or equal to 3.0, and is more preferably less than or equal to 2.5. Log Pₐᵥₑ, for example, is greater than or equal to 0.5, but may be less than 0.5. In a case where Log Pₐᵥₑ is in the range described above, it is preferable since it is possible to further decrease the oxygen permeability of the wavelength conversion layer, and to further prevent the quantum dot contained in the wavelength conversion layer from being in contact with oxygen.

$$Log Pave = \frac{\sum Log Pi \times Wi}{\sum Wi} \qquad Expression 3$$

In the expression described above, in a case where the n types of the polymerizable compounds described above are numbered in an arbitrary order, Wᵢ is the mass of the i-th polymerizable compound contained in the polymerizable composition described above, Log Pᵢ is a Log P value of the i-th polymerizable compound, and i is an integer from 1 to n. Furthermore, for example, as described above, in a case where the compounds A, B, and C are contained in the polymerizable composition described above, Log Pₐᵥₑ is calculated as described below. In the below description, Log P_{A} is a Log P value of the compound A, and W_{A} is the mass of the compound A contained in the polymerizable composition described above. The same applies to Log P_{B}, Log P_{C}, W_{B}, and W_{C} of each of the compounds B and C.

$$Log {P}_{ave} = \frac{Log {P}_{A} \times {W}_{A} + Log {P}_{B} \times {W}_{B} + Log {P}_{C} \times {W}_{C}}{{W}_{A} + {W}_{B} + {W}_{C}}$$

(Preferred Aspect of Other Polymerizable Compound)

Preferred aspects of the other polymerizable compound capable of being used together with the first polymerizable compound can include a polymerizable compound in which the number of polymerizable functional groups in one molecule is greater than or equal to 2 (hereinafter, referred to as a “second polymerizable compound”). The second polymerizable compound is preferably a polymerizable compound having two or more polymerizable functional groups selected from the group consisting of a (meth)acryloyl group, a vinyl group, an epoxy group, and an oxetanyl group in one molecule. The quantum dot-containing polymerizable composition contains the second polymerizable compound, and thus, it is possible to increase a crosslinking density of the polymer in the wavelength conversion layer which is formed by curing the quantum dot-containing polymerizable composition. As a result thereof, it is possible to improve heat resistance of the wavelength conversion layer. Accordingly, it is possible to suppress a decrease in the backlight brightness when a wavelength conversion member including the wavelength conversion layer, and a backlight unit or a liquid crystal display device including the wavelength conversion member are used after being stored at a high temperature. The polymerizable composition may contain one type of polymerizable compound, or may contain two or more types of polymerizable compounds having different structures, as the second polymerizable compound. It is preferable that 1 to 49 parts by mass of the second polymerizable compound is used, and it is more preferable that 5 to 25 parts by mass of the second polymerizable compound is used, with respect to 100 parts by mass of the total amount of the polymerizable compound contained in the polymerizable composition described above.

Specific aspects of the second polymerizable compound can include a difunctional or higher (meth)acrylate compound having two or more (meth)acryloyl groups. Preferred examples of the difunctional or higher (meth)acrylate compound include neopentyl glycol di(meth)acrylate, 1,9-nonane diol di(meth)acrylate, 1,6-hexane diol di(meth)acrylate, tripropylene glycol di(meth)acrylate, ethylene glycol di(meth)acrylate, tetraethylene glycol di(meth)acrylate, hydroxy pivalic acid neopentyl glycol di(meth)acrylate, polyethylene glycol di(meth)acrylate, dicyclopentenyl (meth)acrylate, dicyclopentenyloxy ethyl (meth)acrylate, dicyclopentanyl di(meth)acrylate, epichlorohydrin (ECH) denatured glycerol tri(meth)acrylate, ethylene oxide (EO) denatured glycerol tri(meth)acrylate, propylene oxide (PO) denatured glycerol tri(meth)acrylate, pentaerythritol tri(meth)acrylate, EO denatured phosphoric acid tri(meth)acrylate, trimethylol propane tri(meth)acrylate, caprolactone denatured trimethylol propane tri(meth)acrylate, EO denatured trimethylol propane tri(meth)acrylate, PO denatured trimethylol propane tri(meth)acrylate, tris(acryloxy ethyl) isocyanurate, dipentaerythritol hexa(meth)acrylate, dipentaerythritol penta(meth)acrylate, caprolactone denatured dipentaerythritol hexa(meth)acrylate, dipentaerythritol hydroxy penta(meth)acrylate, alkyl denatured dipentaerythritol penta(meth)acrylate, dipentaerythritol poly(meth)acrylate, alkyl denatured dipentaerythritol tri(meth)acrylate, ditrimethylol propane tetra(meth)acrylate, pentaerythritol ethoxy tetra(meth)acrylate, pentaerythritol tetra(meth)acrylate, tricyclodecane dimethanol di(meth)acrylate, denatured bisphenol A di(meth)acrylate, and the like.

Other specific aspects of the second polymerizable compound can include a polymerizable compound having two or more polymerizable functional groups selected from the group consisting of an epoxy group and an oxetanyl group. Preferred examples of such a polymerizable compound include an aliphatic cyclic epoxy compound, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butane diol diglycidyl ether, 1,6-hexane diol diglycidyl ether, glycerin triglycidyl ether, trimethylol propane triglycidyl ether, polyethylene glycol diglycidyl ether, polypropylene glycol diglycidyl ethers; polyglycidyl ethers of polyether polyol obtained by adding one type or two or more types of alkylene oxides to aliphatic polyhydric alcohol such as ethylene glycol, propylene glycol, and glycerin; diglycidyl esters of an aliphatic long-chain dibasic acid; glycidyl esters of a higher fatty acid; a compound containing epoxy cycloalkane, and the like.

Examples of a commercially available product which can be preferably used as the polymerizable compound having two or more polymerizable functional groups selected from the group consisting of an epoxy group and an oxetanyl group include CELLOXIDE 2021P and CELLOXIDE 8000 manufactured by Daicel Corporation, 4-vinyl cyclohexene dioxide manufactured by Sigma-Aldrich Co. LLC, and the like.

The polymerizable compound having two or more polymerizable functional groups selected from the group consisting of an epoxy group and an oxetanyl group, for example, can be synthesized with reference to literatures such as The Fourth Series of Experimental Chemistry 20 Organic Synthesis II, Page 213, 1992, Ed. by Alfred Hasfner, The Chemistry of Heterocyclic Compounds-Small Ring Heterocycles Part 3 Oxiranes published by Maruzen Publishing Co. Ltd., An Interscience Publication, New York, 1985, YOSHIMURA, Adhesion, Volume 29, Issue 12, Page 32, 1985, YOSHIMURA, Adhesion, Volume 30, Issue 5, Page 42, 1986, YOSHIMURA, Adhesion, Volume 30, Issue 7, Page 42, 1986 published by John & Wiley and Sons Inc., JP1999-100378A (JP-H11-100378A), JP2906245B, and JP2926262B. Here, a manufacturing method is not particularly limited.

Other specific aspects of the second polymerizable compound can include a polymerizable compound having two or more vinyl groups. Preferred examples of such a polymerizable compound include divinyl benzene, divinyl ether, divinyl sulfone, divinyl siloxane, and the like.

In addition, the second polymerizable compound can be a polymerizable compound having two or more different types of polymerizable functional groups. Preferred examples of such a polymerizable compound include glycidyl (meth)acrylate, (3-ethyl oxetane-3-yl) methyl acrylate, tetrahydrofurfuryl acrylate, 4-hydroxy butyl acrylate glycidyl ether, 3,4-epoxy cyclohexyl methyl methacrylate (examples of a commercially available product include CYCLOMER M100 manufactured by Daicel Corporation), vinyl cyclohexene dioxide, an isocyanuric acid derivative (Product Name: MA-DGIC and DA-MGIC) manufactured by SHIKOKU CHEMICALS CORPORATION, and the like.

(resin)

The quantum dot-containing polymerizable composition, as necessary, may contain one or more types of resins. A weight-average molecular weight of the resin is preferably greater than or equal to 1,000, is more preferably greater than or equal to 2,000, and is even more preferably greater than or equal to 3,000, from the viewpoint of further suppressing the polymerization contraction. In addition, it is preferable that the weight-average molecular weight described above is less than or equal to 1,000,000 from the viewpoint of the solubility with respect to the first polymerizable compound and the coating suitability (the viscosity) of the polymerizable composition. Examples of a preferred resin include a polyester resin, a (meth)acrylic resin, a methacrylic acid-maleic acid copolymer, a polystyrene resin, a fluorine resin, a polyimide resin, a polyether imide resin, a urethane resin, a polyether ether ketone resin, a polycarbonate resin, a polyacrylonitrile resin, a polyvinyl chloride resin, a polyarylate resin, a polyether sulfone resin, a polysulfone resin, a triacetyl cellulose (TAC) resin, an acrylonitrile butadiene styrene (ABS) resin, nylon 6, nylon 66, a polyvinylidene chloride resin, a polyvinylidene fluoride resin, an ethylene-vinyl alcohol (EVOH) copolymer resin, a polyvinyl butyrate resin, and a polyvinyl alcohol resin. In addition, the resin may be a denatured resin in which a part of the repeating unit of the resin described above is different. Among them, the (meth)acrylic resin, the polyvinyl butyrate resin, the polyvinyl alcohol resin, the polyvinylidene chloride resin, and the ethylene-vinyl alcohol copolymer resin are preferable from the viewpoint of enabling the oxygen permeability of the wavelength conversion layer to decrease.

Examples of a commercially available product include MOWITAL and KURARAY POVAL manufactured by KURARAY CO., LTD., SOARNOL and GOHSENOL manufactured by The Nippon Synthetic Chemical Industry Co., Ltd., ACRYPET and DIANAL manufactured by Mitsubishi Rayon Co., Ltd., and ARUFON UP series, UC series, and UF series manufactured by Toagosei Chemical Industry Co., Ltd.

In addition, from the same reason as that described in the second polymerizable compound, it is also preferable that the resin described above contains one type or two or more types of a polarity group such as a hydroxyl group and a nitrile group, a chlorine atom, and a fluorine atom in the repeating unit.

(Viscosity Adjuster)

The quantum dot-containing polymerizable composition, as necessary, may contain a viscosity adjuster. It is preferable that the viscosity adjuster is a filler having a particle diameter of 5 nm to 300 nm. In addition, it is also preferable that the viscosity adjuster is a thixotropic agent. Furthermore, in the present invention and in this specification, thixotropy indicates properties in which a viscosity decreases as a shearing speed increases in a liquid composition, and the thixotropic agent indicates a material having a function of imparting thixotropy to a composition by being contained in the liquid composition. Specific examples of the thixotropic agent include fumed silica, alumina, silicon nitride, titanium dioxide, calcium carbonate, zinc oxide, talc, mica, feldspar, kaolinite (kaolin clay), phyllosilicate (agalmatolite clay), sericite, bentonite, smectite.vermiculites (montmorillonite, beidellite, nontronite, saponite, and the like), organic bentonite, organic smectite, and the like.

In an aspect, the viscosity of the quantum dot-containing polymerizable composition is 3 to 100 mPa·s at a shearing speed of 500 s⁻¹, and is preferably greater than or equal to 300 mPa·s at a shearing speed of 1 s⁻¹. In order to adjust the viscosity as described above, it is preferable to use the thixotropic agent. In addition, the reason that the viscosity of the quantum dot-containing polymerizable composition is 3 to 100 mPa·s at a shearing speed of 500 s⁻¹, and is preferably greater than or equal to 300 mPa·s at a shearing speed of 1 s⁻¹ is as described below.

Examples of a manufacturing method of a wavelength conversion member can include a manufacturing method including a step of applying a quantum dot-containing polymerizable composition onto a first base material, and then, of bonding a second base material onto the quantum clot-containing polymerizable composition, and after that, of forming a wavelength conversion layer by curing the quantum dot-containing polymerizable composition, as described below. In the manufacturing method described above, it is desirable that when the quantum dot polymerizable compound is applied onto the first base material, the coating is evenly performed such that a coating streak does not occur, and thus, a thickness of a coated film is even, and for this reason, it is preferable that a viscosity of a coating liquid (the quantum dot-containing polymerizable composition) is low from the viewpoint of coating properties and levelability. On the other hand, in order to evenly bond the second base material onto the coating liquid applied onto the first base material, it is preferable that a resistance force with respect to a pressure at the time of performing bonding is high, and from this viewpoint, a coating liquid having a high viscosity is preferable. The shearing speed of 500 s⁻¹ described above is a representative value of a shearing speed which is applied to the coating liquid to be applied onto the first base material, and the shearing speed of 1 s⁻¹ is a representative value of a shearing speed which is applied to the coating liquid immediately before the second base material is bonded onto the coating liquid. Furthermore, the shearing speed of 1 s⁻¹ is merely a representative value. When the second base material is bonded onto the coating liquid which is applied onto the first base material, and the bonding is performed while handling the first base material and the second base material at the same speed, the shearing speed which is applied to the coating liquid is approximately 0 s⁻¹, and in an actual manufacturing step, the shearing speed which is applied to the coating liquid is not limited to 1 s⁻¹. The shearing speed of 500 s⁻¹ is also merely a representative value, and in the actual manufacturing step, the shearing speed which is applied to the coating liquid is not limited to 500 s⁻¹. Then, from the viewpoint of even coating and even bonding, it is preferable that the viscosity of the quantum dot-containing polymerizable composition is adjusted to be 3 to 100 mPa·s at the representative value of 500 s⁻¹ of the shearing speed which is applied to the coating liquid at the time of applying the coating liquid onto the first base material, and is adjusted to be greater than or equal to 300 mPa·s at the representative value of 1 s⁻¹ of the shearing speed which is applied to the coating liquid immediately before the second base material is bonded onto the coating liquid which is applied onto the first base material.

(Rubber Particles)

The quantum dot-containing polymerizable composition may contain rubber particles. By containing the rubber particles, it is possible to prevent the wavelength conversion layer from being brittle. Examples of the rubber particles include a rubber-like polymer containing acrylic acid ester as a main constituent monomer, a rubber-like polymer containing butadiene as a main constituent monomer, an ethylene-vinyl acetate copolymer, and the like. Only one type of rubber particles may be independently used, or two or more types thereof may be used by being mixed. The rubber particles can be referred to the description in paragraphs 0061 to 0069 of JP2014-35393A.

(Polymerization Initiator)

The quantum dot-containing polymerizable composition may contain a known polymerization initiator such as a radical polymerization initiator, a cationic polymerization initiator, and an anionic polymerization initiator. A preferred aspect of the polymerization initiator is a photopolymerization initiator.

The radical polymerization initiator, for example, can be referred to paragraph 0037 of JP2013-043382A and paragraphs 0040 to 0042 of JP2011-159924A.

In a case where the quantum dot-containing polymerizable composition contains a polymerizable compound having a polymerizable functional group selected from the group consisting of an epoxy group and an oxetanyl group, it is preferable that the quantum dot-containing polymerizable composition contains a photocationic polymerization initiator or a photoanionic polymerization initiator. The photocationic polymerization initiator, for example, can be referred to paragraphs 0019 to 0024 of JP4675719B. In addition, the photoanionic polymerization initiator, for example, can be referred to paragraphs 0039 to 0053 of JP2013-235216A. It is preferable that a polymerizable compound having an epoxy group is a polymerizable compound having an alicyclic epoxy group from the viewpoint of the curing properties.

Examples of a preferred photocationic polymerization initiator can include an iodonium salt compound, a sulfonium salt compound, a pyridinium salt compound, and a phosphonium salt compound. For example, CH₃SO₃⁻, C₆H₅SO₃⁻, CF₃SO₃⁻, PF₆⁻, HSbF₆⁻, and HB(C₆F₅)₄⁻ can be exemplified as an anionic site (a counter anion) included in such a salt compound. Among them, the iodonium salt compound, the sulfonium salt compound, the pyridinium salt compound, and the phosphonium salt compound, in which a gas-phase acidity of the anionic site is in a range of 240 to 290 kcal/mol, are preferable from the viewpoint of a curing speed. The gas-phase acidity is more preferably in a range of 240 to 280 kcal/mol, and is even more preferably in a range of 240 to 270 kcal/mol. Here, the “gas-phase acidity” is an acidity in a gas phase, and a change in GIBBS energy according to acidic dissociation is defined by international union of pure and applied chemistry (IUPAC). The gas-phase acidity can be calculated by a known computational software.

Among them, the iodonium salt compound and the sulfonium salt compound are preferable from the viewpoint of excellent heat stability, and the iodonium salt compound is particularly preferable from the viewpoint of suppressing absorption of light derived from the light source of the wavelength conversion layer and of improving a brightness. Absorption of a decomposition product of a photopolymerization initiator is considered as one reason that the wavelength conversion layer absorbs the light derived from the light source, and the present inventors have assumed that the iodonium salt compound rarely generates a decomposition product which becomes one reason for such absorption. Here, the above description is an assumption of the present inventors, and the present invention is not limited thereto.

It is more preferable that the iodonium salt compound is a salt formed by a cationic site having F in a structure and an anionic site of an arbitrary structure, and is a diaryl iodonium salt in which three or more electron donating groups are included, and at least one of them is an alkoxy group. Thus, it is considered that the alkoxy group which is the electron donating group is introduced into the diaryl iodonium salt, and thus, decomposition due to water or a nucleophilic agent over time, or electron movement due to heat can be suppressed, and therefore, stability is improved. Specific examples of the iodonium salt compound having such a structure can include photocationic polymerization initiators (iodonium salt compounds) A and B described below. In addition, specific examples of the iodonium salt compound having an anionic site of which the gas-phase acidity is in a range of 240 to 290 kcal/mol can include a photocationic polymerization initiator (an iodonium salt compound) C described below.

### Photocationic Polymerization Initiator (Iodonium Salt Compound) A

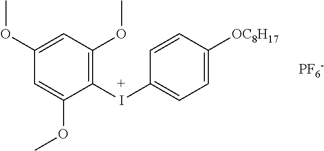

### Photocationic Polymerization Initiator (Iodonium Salt Compound) B

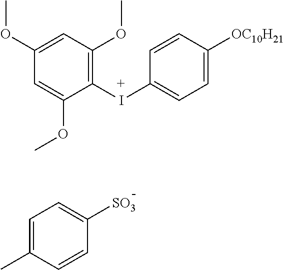

### Photocationic Polymerization Initiator (Iodonium Salt Compound) C

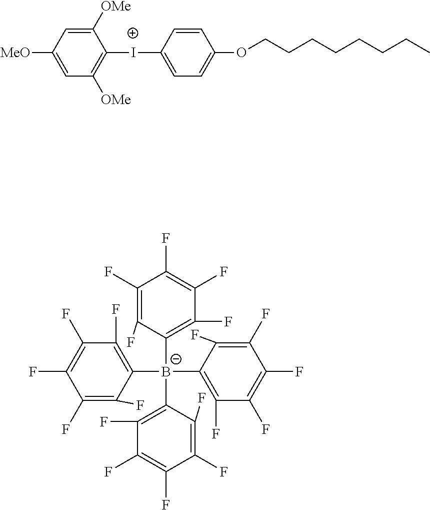 [SMILES: CCCCCCCCOc1ccc([I+]c2c(OC)cc(OC)cc2OC)cc1 ; Fc1c(F)c(F)c([B-](c2c(F)c(F)c(F)c(F)c2F)(c2c(F)c(F)c(F)c(F)c2F)c2c(F)c(F)c(F)c(F)c2F)c(F)c1F]

The photocationic polymerization initiator contained in the quantum dot-containing polymerizable composition is not limited to the iodonium salt compound. Examples of the photocationic polymerization initiator which can be used can include combinations of one type or two or more types of commercially available products described below: CPI-110P (a photocationic polymerization initiator D described below), CPI-101A, CPI-110P, and CPI-200K manufactured by San-Apra Ltd., WPI-113, WPI-116, WPI-124, WPI-169, and WPI-170 manufactured by Wako Pure Chemical Industries, Ltd., PI-2074 manufactured by Rhodia, Inc., IRGACURE (Registered Trademark) 250, IRGACURE 270, and IRGACURE 290 (a photocationic polymerization initiator E described below) manufactured by BASF SE.

Photocationic Polymerization Initiator D (CPI-110P manufactured by San-Apro Ltd.)

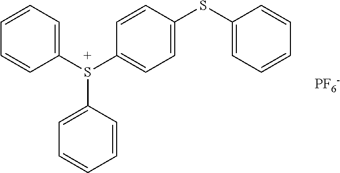

Photocationic Polymerization Initiator E (IRGACURE 290 manufactured by BASF SE)

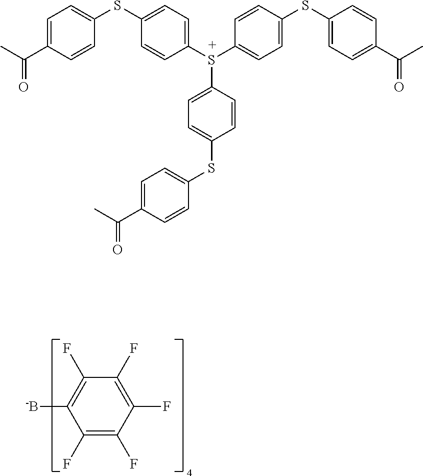

The polymerization initiator content contained in the quantum dot-containing polymerizable composition is preferably greater than or equal to 0.1 mol %, and is more preferably 0.5 to 5 mol %, with respect to the total amount of the polymerizable compound contained in the quantum dot-containing polymerizable composition. In addition, in a case where the polymerization initiator contains a volatile solvent, the content of the polymerization initiator with respect to 100 parts by mass of the total amount of the quantum dot-containing polymerizable composition except for the volatile solvent is preferably 0.1 to 10 parts by mass, is more preferably 0.2 to 8 parts by mass, and is even more preferably 0.2 to 5 parts by mass. It is preferable that a suitable amount of polymerization initiator is used from the viewpoint of decreasing light irradiation dose for performing curing and from the viewpoint of enabling the entire wavelength conversion layer to be evenly cured.

(Solvent)

The quantum dot-containing polymerizable composition, as necessary, may contain a solvent. In this case, the type and an added amount of the solvent to be used are not particularly limited. For example, one type or two or more types of organic solvents can be used by being mixed as the solvent.

(Formation Method of Wavelength Conversion Layer)

The wavelength conversion layer can be formed by applying the quantum dot-containing polymerizable composition, for example, onto a surface of a base material, and then, curing the quantum dot-containing polymerizable composition by light irradiation or heating.

Examples of a coating method include a known coating method such as a curtain coating method, a dip coating method, a spin coating method, a printing coating method, a spray coating method, a slot coating method, a roll coating method, a slide coating method, a blade coating method, a gravure coating method, and a wire bar method.

Curing conditions can be suitably set according to the type of the polymerizable compound to be used or the composition of the polymerizable composition. In addition, in a case where the quantum dot-containing polymerizable composition is a composition containing a solvent, a drying treatment for removing the solvent may be performed before performing curing.

In order to improve the adhesiveness between the wavelength conversion layer and the adjacent layer, an organic metal coupling agent for improving the adhesiveness between the wavelength conversion layer and the adjacent layer may be contained in any one or both of the wavelength conversion layer or the layer adjacent to the wavelength conversion layer. For example, various coupling agents such as a silane coupling agent, a titanium coupling agent, a zirconium coupling agent, an aluminum coupling agent, and a tin coupling agent can be used as the organic metal coupling agent. In a case where the layer adjacent to the wavelength conversion layer is a layer of an inorganic material such as a metal, a metal oxide, and a metal nitride or in a case where the layer adjacent to the wavelength conversion layer is a layer containing the inorganic materials in a resin, the organic metal coupling agents are particularly preferable because of a profound effect of increasing the adhesiveness.

Examples of the silane coupling agent include vinyl trichlorosilane, vinyl trimethoxy silane, vinyl triethoxy silane, 2-(3,4-epoxy cyclohexyl)ethyl trimethoxy silane, 3-glycidoxy propyl trimethoxy silane, 3-glycidoxy propyl methyl diethoxy silane, 3-glycidoxy propyl triethoxy silane, p-styryl trimethoxy silane, 3-methacryloxy propyl methyl dimethoxy silane, 3-methacryloxy propyl trimethoxy silane, 3-methacryloxy propyl methyl diethoxy silane, 3-methacryloxy propyl triethoxy silane, 3-acryloxy propyl trimethoxy N-2-(aminoethyl)-3-aminopropyl methyl dimethoxy silane, N-2-(aminoethyl)-3-aminopropyl trimethoxy silane, N-2-(aminoethyl)-3-aminopropyl triethoxy silane, 3-aminopropyl trimethoxy silane, 3-aminopropyl triethoxy silane, 3-triethoxy silyl-N-(1,3-dimethyl-butylidene) propyl amine and a partial hydrolysate thereof, 3-trimethoxy silyl-(1,3-dimethyl-butylidene) propyl amine and a partial hydrolysate thereof, N-phenyl-3-aminopropyl trimethoxy silane, 3-mercaptopropyl methyl dimethoxy silane, 3-mercaptopropyl trimethoxy silane, 3-isocyanate propyl triethoxy silane, and the like. Among them, a vinyl denatured silane coupling agent, an epoxy denatured silane coupling agent, a (meth)acryloyloxy denatured silane coupling agent, an amino denatured silane coupling agent, and an isocyanate denatured silane coupling agent are preferable, and the (meth)acryloyloxy denatured silane coupling agent is particularly preferable. Only one type of the silane coupling agent can be independently used, or two or more types thereof can be used in combination.

Examples of a commercially available product of the silane coupling agent which can be preferably used can include commercially available products manufactured by Shin-Etsu Chemical Co., Ltd. Examples of the commercially available product include KBM-502, KBM-503, KBM-5103, KBE-502, KBE-503, KBM-903, KBM-9103, and the like, manufactured by Shin-Etsu Chemical Co., Ltd.

In addition, examples of the silane coupling agent can include a silane coupling agent represented by General Formula (1) described in JP2013-43382A. The details thereof can be referred to the description in paragraphs 0011 to 0016 of JP2013-43382A.

Examples of the titanium coupling agent include isopropyl triisostearoyl titanate, isopropyl tridodecyl benzene sulfonyl titanate, isopropyl tris(dioctyl pyrophosphate) titanate, tetraisopropyl bis(dioctyl phosphite) titanate, tetraoctyl bis(ditridecyl phosphite) titanate, tetra(2,2-diallyloxy methyl) bis(ditridecyl) phosphite titanate, bis(dioctyl pyrophosphate) oxy acetate titanate, bis(dioctyl pyrophosphate) ethylene titanate, isopropyl trioctanoyl titanate, isopropyl dimethacryl isostearoyl titanate, isopropyl isostearoyl diacryl titanate, isopropyl tri(dioctyl phosphate) titanate, isopropyl tricumyl phenyl titanate, isopropyl tri(N-aminoethyl.aminoethyl) titanate, dicumyl phenyloxy acetate titanate, diisostearoyl ethylene titanate, and the like.

Examples of the zirconium coupling agent include tetra-n-propoxy zirconium, tetra-butoxy zirconium, zirconium tetraacetyl acetonate, zirconium dibutoxy bis(acetyl acetonate), zirconium tributoxy ethyl acetoacetate, zirconium butoxy acetyl acetonate bis(ethyl acetoacetate), and the like.

Examples of the aluminum coupling agent can include aluminum isopropylate, monosec-butoxy aluminum diisopropylate, aluminum sec-butyrate, aluminum ethylate, ethyl acetoacetate aluminum diisopropylate, aluminum tris(ethyl acetoacetate), alkyl acetoacetate aluminum diisopropylate, aluminum monoacetyl acetonate bis(ethyl acetoacetate), aluminum tris(acetyl acetoacetate), and the like.

A commercially available product or a coupling agent which is synthesized by a known method can be used as the titanium coupling agent, the zirconium coupling agent, and the aluminum coupling agent as described above without any limitation. The same applies to the tin coupling agent.

In an aspect, by using the quantum dot-containing polymerizable composition containing the organic metal coupling agent, it is possible to form a wavelength conversion layer containing the organic metal coupling agent. From the viewpoint of further improving the adhesiveness between the wavelength conversion layer and the adjacent layer, the content of the organic metal coupling agent in the quantum dot-containing polymerizable composition is preferably in a range of 1 to 30 parts by mass, is more preferably in a range of 3 to 30 parts by mass, and is even more preferably in a range of 5 to 25 parts by mass, with respect to 100 parts by mass of the total mass of the quantum dot-containing polymerizable composition except for the mass of the quantum dot and the mass of the solvent.

In addition, in another aspect, it is possible to laminate the wavelength conversion layer and the adjacent layer by performing a surface treatment with respect to the surface of the wavelength conversion layer and the surface of the adjacent layer with the organic metal coupling agent, and then, by bonding the surface of the wavelength conversion layer onto the surface of the adjacent layer. The surface treatment, for example, can be performed by applying the organic metal coupling agent and an organic metal coupling agent-containing composition containing a solvent onto a surface of a treatment target. In a case where the organic metal coupling agent has a functional group (a hydrolyzable group) which can be hydrolyzed in the presence of water, water or a mixed solvent of water and an organic solvent is preferable as the solvent. Examples of the organic solvent to be used together with water include alcohol, but the organic solvent is not particularly limited. In addition, the organic metal coupling agent-containing composition may contain an acid for accelerating hydrolysis. Examples of the acid can include an acetic acid, but the acid is not limited thereto. In the organic metal coupling agent-containing composition, the amount of organic metal coupling agent, the amount of solvent, and a content of a component to be arbitrary added, such as an acid may be suitably adjusted. A coating method of the organic metal coupling agent-containing composition is also not particularly limited, but it is preferable that the surface treatment is performed in a roll-to-roll manner from the viewpoint of productivity. Specifically, it is possible to perform coating and drying with respect to the organic metal coupling agent-containing composition on a film including at least a layer of a treatment target in the roll-to-roll manner by using a known coating machine. An inorganic layer is preferable as such a layer to be subjected to the surface treatment. By performing the surface treatment described above, it is possible to further increase adhesiveness between the inorganic layer and the wavelength conversion layer.

The quantum dot-containing polymerizable composition may be cured in a state where the quantum dot-containing polymerizable composition is sandwiched between two base materials. Hereinafter, an aspect of a manufacturing step of the wavelength conversion member, in which a curing treatment is included, will be described with reference to the drawings. Here, the present invention is not limited to the aspect described below

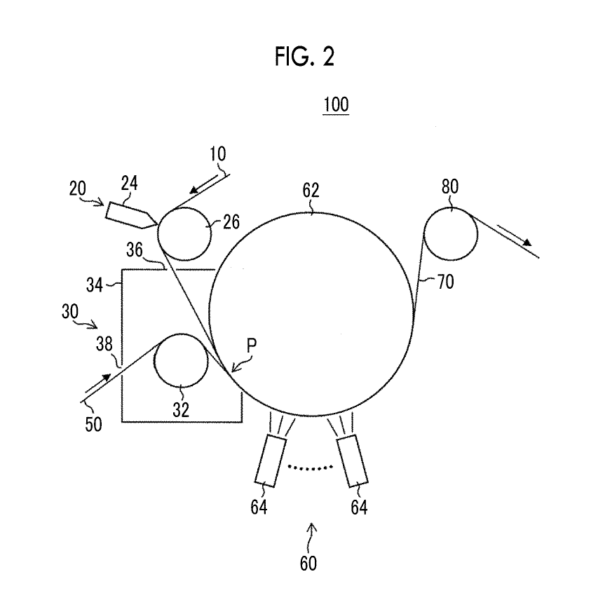

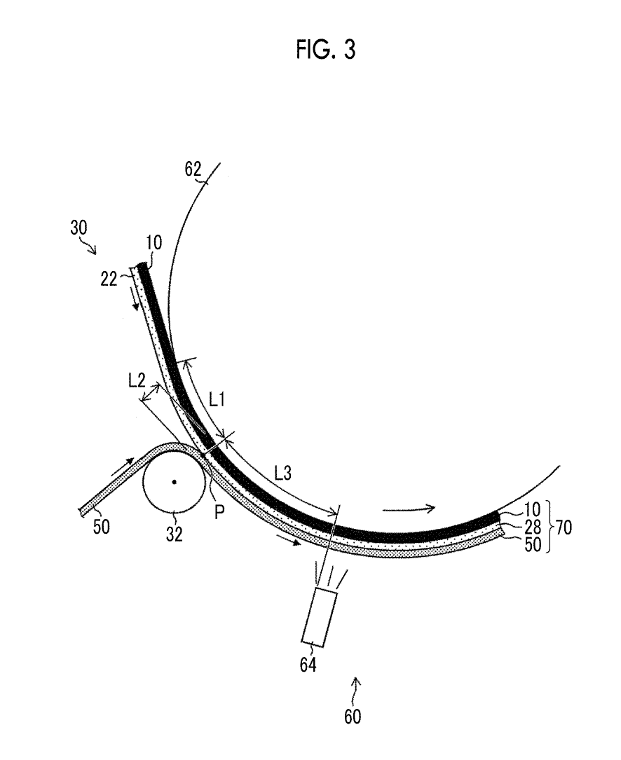

FIG. 2 is a schematic configuration diagram of an example of a manufacturing device of a wavelength conversion member, and FIG. 3 is a partially enlarged view of the manufacturing device illustrated in FIG. 2. The manufacturing step of the wavelength conversion member, in which the manufacturing device illustrated in FIGS. 2 and 3 is used, includes at least a step of forming a coated film by applying the quantum dot-containing polymerizable composition onto a surface of a first base material (hereinafter, referred to as a “first film”) which is continuously handled, a step of laminating (superimposing) a second base material (hereinafter, referred to as a “second film”) which is continuously handled on the coated film and of sandwiching the coated film between the first film and the second film, and a step of winding any one of the first film and the second film around a backup roller in a state where the coated film is sandwiched between the first film and the second film, of performing light irradiation with respect to the coated film while continuously handling the film, of polymerizing and curing the coated film, and of forming a wavelength conversion layer (a cured layer). By using a barrier film having barrier properties with respect to oxygen or moisture as any one of the first film and the second film, it is possible to obtain a wavelength conversion member of which one surface is protected with the barrier film. In addition, by using a barrier film as each of the first film and the second film, it is possible to obtain a wavelength conversion member in which both surfaces of a wavelength conversion layer are protected with the barrier film.

More specifically, first, a first film 10 is continuously handled to a coating unit 20 from a feeding machine (not illustrated). For example, the first film 10 is fed at a handling speed of 1 to 50 m/minute from the feeding machine. Here, the handling speed is not limited thereto. For example, a tensile force of 20 to 150 N/m, preferably a tensile force of 30 to 100 N/m is applied to the first film 10 at the time of being fed.

In the coating unit 20, the quantum dot-containing polymerizable composition (hereinafter, also referred to as a “coating liquid”) is applied onto the surface of the first film 10 which is continuously handled, and thus, a coated film 22 (refer to FIG. 3) is formed. The coating unit 20, for example, includes a die coater 24, and a backup roller 26 disposed to face the die coater 24. A surface of the first film 10 on a side opposite to the surface on which the coated film 22 is formed is wound around a backup roller 26, and the coating liquid is applied onto the surface of the first film 10 which is continuously handled from an ejection port of the die coater 24, and thus, the coated film 22 is formed. Here, the coated film 22 indicates the quantum dot-containing polymerizable composition applied onto the first film 10 before being cured.

In this embodiment, the die coater 24 to which an extrusion coating method is applied is described as a coating device, but the coating device is not limited thereto. For example, a coating device to which various methods such as a curtain coating method, an extrusion coating method, a rod coating method, or a roll coating method are applied can be used.

The first film 10 on which the coated film 22 is formed is continuously handled to a laminating unit 30 through the coating unit 20. In the laminating unit 30, a second film 50 which is continuously handled is laminated on the coated film 22, and thus, the coated film 22 is sandwiched between the first film 10 and the second film 50. Furthermore, in a case where the quantum dot-containing polymerizable composition contains a solvent, a drying zone (not illustrated) may be disposed in an arbitrary position before the laminating unit 30 in order to remove the solvent. A drying treatment in the drying zone can be performed by a known method such as passing through a heating atmosphere and blowing off drying air.

The laminating unit 30 includes a laminating roller 32, and a heating chamber 34 surrounding the laminating roller 32. The heating chamber 34 includes an opening portion 36 for allowing the first film 10 to pass therethrough, and an opening portion 38 for allowing the second film 50 to pass therethrough.

A backup roller 62 is disposed in a position facing the laminating roller 32. In the first film 10 on which the coated film 22 is formed, the surface on a side opposite to the surface on which the coated film 22 is formed is wound around the backup roller 62, and is continuously handled to a lamination position P. The lamination position P indicates a position in which the second film 50 starts to be in contact with the coated film. It is preferable that the first film 10 is wound around the backup roller 62 before reaching the lamination position P. This is because even in a case where wrinkles are generated on the first film 10, the wrinkles can be reformed and removed by the backup roller 62 until the first film 10 reaches the lamination position P. Therefore, it is preferable that a distance L1 between the position (a contact position) where the first film 10 is wound around the backup roller 62 and the lamination position P is long, and for example, the distance L1 is preferably greater than or equal to 30 mm, and the upper limit value, in general, is determined according to the diameter and a pass line of the backup roller 62.

In this embodiment, the second film 50 is laminated by the backup roller 62 which is used in a curing unit 60 and the laminating roller 32. That is, the backup roller 62 which is used in the curing unit 60 is also used as a roller which is used in the laminating unit 30. Here, the configuration is not limited to the above description, but a roller for lamination is disposed in the laminating unit 30, separately from the backup roller 62, such that the backup roller 62 is not also used as the roller which is used in the laminating unit 30.

By using the backup roller 62 which is used in the curing unit 60 in the laminating unit 30, it is possible to decrease the number of rollers. In addition, the backup roller 62 can also be used as a heat roller with respect to the first film 10.

The second film 50 fed from the feeding machine (not illustrated) is wound around the laminating roller 32, and is continuously handled between the laminating roller 32 and the backup roller 62. In the lamination position P, the second film 50 is laminated on the coated film 22 which is formed on the first film 10. Accordingly, the coated film 22 is sandwiched between the first film 10 and the second film 50. The lamination indicates that the second film 50 is laminated on the coated film 22 by being superimposed.

It is preferable that a distance L2 between the laminating roller 32 and the backup roller 62 is greater than or equal to the value of the total thickness of the first film 10, a wavelength conversion layer (a cured layer) 28 formed by polymerizing and curing the coated film 22, and the second film 50. In addition, it is preferable that L2 is less than or equal to a length obtained by adding 5 mm to the total thickness of the first film 10, the coated film 22, and the second film 50. By setting the distance L2 to be less than or equal to the length obtained by adding 5 mm to the total thickness, it is possible to prevent bubbles from entering between the second film 50 and the coated film 22. Here, the distance L2 between the laminating roller 32 and the backup roller 62 indicates the shortest distance between an outer circumferential surface of the laminating roller 32 and an outer circumferential surface of the backup roller 62.

A rotation accuracy of the laminating roller 32 and the backup roller 62 is less than or equal to 0.05 mm, and is preferably less than or equal to 0.01 mm, in radial deflection. It is possible to decrease a thickness distribution of the coated film 22 as the radial deflection becomes small.

In addition, in order to suppress thermal deformation after sandwiching the coated film 22 between the first film 10 and the second film 50, a difference between the temperature of the backup roller 62 in the curing unit 60 and the temperature of the first film 10, and a difference between the temperature of the backup roller 62 and the temperature of the second film 50 are preferably lower than or equal to 30° C., and are more preferably lower than or equal to 15° C., and it is most preferable that the temperatures are identical to each other.

In a case where a heating chamber 34 is disposed in order to decrease the difference with respect to the temperature of the backup roller 62, it is preferable that the first film 10 and the second film 50 are heated in the heating chamber 34. For example, in the heating chamber 34, hot air is supplied by a hot air generating device (not illustrated), and thus, it is possible to heat the first film 10 and the second film 50.

The first film 10 is wound around the backup roller 62 of which the temperature is adjusted, and thus, the first film 10 may be heated by the backup roller 62.

On the other hand, in the second film 50, the laminating roller 32 is set to a heat roller, and thus, it is possible to heat the second film 50 by the laminating roller 32.

Here, the heating chamber 34 and the heat roller are not essential constituents, and can be disposed as necessary.

Next, the coated film 22 is continuously handled to the curing unit 60 in a state of being sandwiched between the first film 10 and the second film 50. In the aspect illustrated in the drawing, the curing in the curing unit 60 is performed by light irradiation, and in a case where the polymerizable compound contained in the quantum dot-containing polymerizable composition is polymerized by heating, the curing can be performed by heating such as blowing off warm air.

A light irradiation device 64 is disposed in a position facing the backup roller 62. The first film 10 and the second film 50 sandwiching the coated film 22 therebetween are continuously handled between the backup roller 62 and the light irradiation device 64. Light emitted from the light irradiation device may be determined according to the type of photopolymerizable compound contained in the quantum dot-containing polymerizable composition, and examples of the light include an ultraviolet ray. Here, the ultraviolet ray indicates light at a wavelength of 280 to 400 nm. For example, a low pressure mercury lamp, a medium pressure mercury lamp, a high pressure mercury lamp, a super high pressure mercury lamp, a carbon arc lamp, a metal halide lamp, a xenon lamp, and the like can be used as a light source emitting an ultraviolet ray. Light irradiation dose may be set in a range where the coated film can be polymerized and cured, and for example, the coated film 22 can be irradiated with an ultraviolet ray having irradiation dose of 100 to 10,000 mJ/cm², as an example.

In the curing unit 60, the first film 10 is wound around the backup roller 62 in a state where the coated film 22 is sandwiched between the first film 10 and the second film 50, the coated film 22 is irradiated with the light from the light irradiation device 64 while being continuously handled, and the coated film 22 is cured, and thus, it is possible to form the wavelength conversion layer (the cured layer) 28.

In this embodiment, the first film 10 side is wound around the backup roller 62 and is continuously handled, but the second film 50 can be wound around the backup roller 62 and can be continuously handled.

Being wound around the backup roller 62 indicates a state where any one of the first film 10 and the second film 50 is in contact with the surface of the backup roller 62 at a certain warp angle. Therefore, the first film 10 and the second film 50 are moved in synchronization with the rotation of the backup roller 62 while being continuously handled. Being wound around the backup roller 62 may be performed while being irradiated with at least an ultraviolet ray.

The backup roller 62 includes a cylindrical main body, and a rotation axis disposed on both end portions of the main body. The main body of the backup roller 62, for example, has a diameter of φ200 to 1,000 mm. The diameter of the backup roller 62 is not limited. In consideration of curling deformation of a laminated film, facility costs, and a rotation accuracy, it is preferable that the diameter is φ300 to 500 mm. By attaching a temperature adjuster to the main body of the backup roller 62, it is possible to adjust the temperature of the backup roller 62.

The temperature of the backup roller 62 can be determined in consideration of heat generated at the time of performing light irradiation, a curing efficiency of the coated film 22, and the occurrence of wrinkle deformation of the first film 10 and the second film 50 on the backup roller 62. The backup roller 62, for example, is preferably set to be in a temperature range of 10° C. to 95° C., and is more preferably set to be in a temperature range of 15° C. to 85° C. Here, the temperature relevant to the roller indicates a surface temperature of the roller.

It is possible to set a distance L3 between the lamination position P and the light irradiation device 64, for example, to be greater than or equal to 30 mm.

The coated film 22 becomes the cured layer 28 by light irradiation, and thus, a wavelength conversion member 70 including the first film 10, the cured layer 28, and the second film 50 is manufactured. The wavelength conversion member 70 is peeled off from the backup roller 62 by a peeling off roller 80. The wavelength conversion member 70 is continuously handled to a winder (not illustrated), and then, the wavelength conversion member 70 is wound in the shape of a roll by the winder.

As described above, the aspect of the manufacturing step of the wavelength conversion member has been described, but the present invention is not limited to the aspect described above. For example, the quantum dot-containing polymerizable composition is applied onto a base material such as a base material or a barrier film, and is cured after the drying treatment which is performed as necessary, without laminating another base material on the base material coated with the quantum dot-containing polymerizable composition, and thus, the wavelength conversion layer (the cured layer) may be formed. One or more other layers such as an inorganic layer can be laminated on the formed wavelength conversion layer by a known method.

The thickness of the wavelength conversion layer is preferably in a range of 1 to 500 μm, is more preferably in a range of 10 to 250 μm, and is even more preferably in a range of 30 to 150 μm. In a case where the thickness is greater than or equal to 1 μm, it is preferable since a high wavelength conversion effect can be obtained. In addition, in a case where the thickness is less than or equal to 500 μm, it is preferable since in a case where the wavelength conversion layer is incorporated in a backlight unit, it is possible to thin the backlight unit.

(Base Material)

The wavelength conversion member may include a base material for improvement in a hardness, ease of film formation, and the like. The base material may be directly in contact with the wavelength conversion layer. One or two or more base materials may be included in the wavelength conversion member, and the wavelength conversion member may have a structure in which the base material, the wavelength conversion layer, and the base material are laminated in this order. In a case where the wavelength conversion member includes two or more base materials, such base materials may be identical to each other or different from each other. It is preferable that the base material is transparent with respect to visible light. Here, being transparent with respect to the visible light indicates that a light ray transmittance in a visible light range is greater than or equal to 80%, and is preferably greater than or equal to 85%. The light ray transmittance which is used as a scale of transparency can be calculated by a method described in JIS-K7105, that is, by measuring the total light ray transmittance and the amount of scattering light with an integrating sphere type light ray transmittance measurement device, and by subtracting a diffusion transmittance from the total light ray transmittance.

The thickness of the base material is in a range of 10 μm to 500 μm from the viewpoint of gas barrier properties, impact resistance, and the like, and among them, a range of 20 to 400 μm is preferable, and a range of 30 to 300 μm is particularly preferable.

In addition, the base material can be used as any one or both of the first film and the second film described above.

The base material can be a barrier film. The barrier film is a film having a gas barrier function of blocking oxygen molecules. It is preferable that the barrier film has a function of blocking water vapor.

The barrier film which can be used as the base material may be any known barrier film, and for example, may be a barrier film described below.

In general, the barrier film may include at least an inorganic layer, or may be a film including a support film and an inorganic layer. The support film, for example, can be referred to paragraphs 0046 to 0052 of 22007-290369A and paragraphs 0040 to 0055 of JP2005-096108. The barrier film may include a barrier laminate including at least one inorganic layer and at least one organic layer on the support film. It is preferable that a plurality of layers are laminated as described above since it is possible to further increase barrier properties. On the other hand, the light transmittance of the wavelength conversion member tends to decrease as the number of layers to be laminated increases, and thus, it is desirable that the number of layers to be laminated increases in a range where an excellent light transmittance can be maintained. Specifically, it is preferable that an oxygen permeability of the base material is less than or equal to 1.00 cm³/(m²·day·atm). In addition, it is preferable that the total light ray transmittance in the visible light range described above is greater than or equal to 80%. Here, the oxygen permeability described above is a value measured by using an oxygen gas permeability measurement device (manufactured by MOCON, Inc., OX-TRAN 2/20: Product Name) under conditions of a measurement temperature of 23° C. and relative humidity of 90%. In addition, the visible light range indicates a wavelength range of 380 to 780 nm, and the total light ray transmittance indicates the average value of the light transmittance in the visible light range.

The oxygen permeability of the base material is more preferably less than or equal to 0.1 cm³/(m²·day·atm), and is even move preferably less than or equal to 0.01 cm³/(m²·day·atm). The total light ray transmittance in the visible light range is more preferably greater than or equal to 90%. It is preferable that the oxygen permeability becomes lower, and it is preferable that the total light ray transmittance in the visible light range becomes higher.

—Inorganic Layer—

The “inorganic layer” is a layer containing an inorganic material as a main component, and is preferably a layer formed only of an inorganic material. In contrast, the organic layer is a layer containing an organic material as a main component, and is preferably a layer containing an organic material of preferably greater than or equal to 50 mass %, more preferably greater than or equal to 80 mass %, and particularly preferably greater than or equal to 90 mass %.

The inorganic material configuring the inorganic layer is not particularly limited, and for example, various inorganic compounds such as a metal, an inorganic oxide, a nitride, and an oxynitride can be used. Silicon, aluminum, magnesium, titanium, tin, indium, and cerium are preferable as an element configuring the inorganic material, and one type or two or more types thereof may be contained. Specific examples of the inorganic compound can include silicon oxide, silicon oxynitride, aluminum oxide, magnesium oxide, titanium oxide, tin oxide, an indium oxide alloy, silicon nitride, aluminum nitride, and titanium nitride. In addition, a metal film, for example, an aluminum film, a silver film, a tin film, a chromium film, a nickel film, and a titanium film may be disposed as the inorganic layer.

In the materials described above, silicon nitride, silicon oxide, or silicon oxynitride is particularly preferable. This is because an inorganic layer formed of such materials has excellent adhesiveness with respect to an organic layer, and thus, it is possible to further increase the barrier properties.

A formation method of the inorganic layer is not particularly limited, and for example, various film formation methods can be used in which a film formation material can be deposited on a surface to be subjected to vapor deposition by being evaporated or scattered.

Examples of the formation method of the inorganic layer include a physical vapor deposition method such as a vacuum vapor deposition method in which vapor deposition is performed by heating an inorganic material such as an inorganic oxide, an inorganic nitride, an inorganic oxynitride, and a metal; an oxidation reaction vapor deposition method in which vapor deposition is performed by using an inorganic material as a raw material, by introducing oxygen gas, and by performing oxidation; a sputtering method in which vapor deposition is performed by using an inorganic material as a target raw material, by introducing argon gas and oxygen gas, and by performing sputtering; and an ion plating method in which vapor deposition is performed by heating an inorganic material with a plasma beam generated front a plasma gun, a plasma chemical vapor deposition method in which an organic silicon compound is used as a raw material in a case where a vapor-deposited film of silicon oxide is formed, and the like. The vapor deposition may be performed with respect to the surface of the support film, the wavelength conversion layer, and the organic layer, and the like by using the support film, the wavelength conversion layer, and the organic layer, and the like as a substrate.

The thickness of the inorganic layer may be 1 nm to 500 nm, is preferably 5 nm to 300 nm, and is particularly preferably 10 nm to 150 nm. This is because it is possible to suppress reflection on the inorganic layer while realizing excellent barrier properties, and it is possible to provide a wavelength conversion member having a higher light transmittance by setting the thickness of the adjacent inorganic layer to be in the range described above.

In the wavelength conversion member, it is preferable that at least one main surface of the wavelength conversion layer is directly in contact with the inorganic layer. It is also preferable that the inorganic layer is directly in contact with both main surfaces of the wavelength conversion layer. In addition, the inorganic layer and the organic layer, two inorganic layers, or two organic layers may be bonded to each other by a known adhesive layer. It is preferable that the adhesive layer is small, and it is more preferable that the adhesive layer does not exist, from the viewpoint of improving the light transmittance. In an aspect, it is preferable that the inorganic layer is directly in contact with the organic layer.

—Organic Layer—

The organic layer can be referred to paragraphs 0020 to 0042 of JP2007-290369A and paragraphs 0074 to 0105 of JP2005-096108A. Furthermore, it is preferable that the organic layer contains a CARDO polymer. Accordingly, adhesiveness between the organic layer and the adjacent layer, in particular, adhesiveness between the organic layer and the inorganic layer becomes excellent, and thus, it is possible to realize more excellent gas barrier properties. The details of the CARDO polymer can be referred to paragraphs 0085 to 0095 of JP2005-096108A described above. The thickness of the organic layer is preferably in a range of 0.05 μm to 10 μm, and among them, a range of 0.5 to 10 μm is preferable. In a case where the organic layer is formed by a wet coating method, the thickness of the organic layer is in a range of 0.5 to 10 μm, and among them, a range of 1 μm to 5 μm is preferable. In addition, in a case where the organic layer is formed by a dry coating method, the thickness of the organic layer is in a range of 0.05 μm to 5 μm, and among them, a range of 0.05 μm to 1 μm is preferable. This is because it is possible to make the adhesiveness with respect to the inorganic layer more excellent by setting the thickness of the organic layer which is formed by the wet coating method or the dry coating method to be in the range described above.

The other details of the inorganic layer and the organic layer can be referred to the descriptions of JP2007-290369A and JP2005-096108A described above, and US2012/0113672A1.

(Scattering Particles)

A light scattering function for efficiently extracting the fluorescent light emitted by the quantum dot from the wavelength conversion layer to the outside may be imparted to the wavelength conversion member. The light scattering function may be disposed in the wavelength conversion layer, or a layer having a light scattering function may be separately disposed as a light scattering layer.

It is also preferable that scattering particles are added into the wavelength conversion layer, as an aspect.

In addition, it is also preferable that the light scattering layer is disposed on the surface of the wavelength conversion layer, as another aspect. The scattering in the light scattering layer may depend on the scattering particles, or may depend on surface unevenness.

[Backlight Unit]

The wavelength conversion member can be used as a constituent of a backlight unit. The backlight unit includes at least the wavelength conversion member and a light source.

(Light Emission Wavelength of Backlight Unit)

It is preferable that a backlight unit including a multiwavelength light source is used as the backlight unit from the viewpoint of realizing a high brightness and a high color reproducibility. For example, it is preferable to emit blue light having a light emission center wavelength in a wavelength range of 430 to 480 nm and a light emission intensity peak of which the half-width is less than or equal to 100 nm, green light having a light emission center wavelength in a wavelength range of 520 to 560 nm and a light emission intensity peak of which the half-width is less than or equal to 100 nm, and red light having a light emission center wavelength in a wavelength range of 600 to 680 nm and a light emission intensity peak of which the half-width is less than or equal to 100 nm.

It is more preferable that a wavelength range of blue light emitted from the backlight unit is in a range of 440 to 460 nm from the viewpoint of further improving the brightness and the color reproducibility.

From the same viewpoint, it is more preferable that a wavelength range of green light emitted from the backlight unit is in a range of 520 to 545 nm.

In addition, from the same viewpoint, it is more preferable that a wavelength range of red light emitted from the backlight unit is in a range of 610 to 640 nm.

In addition, from the same viewpoint, all half-widths of light emission intensities of each of the blue light, the green light, and the red light emitted from the backlight unit are preferably less than or equal to 80 nm, are more preferably less than or equal to 50 nm, are even more preferably less than or equal to 40 nm, and are further even more preferably less than or equal to 30 nm. Among them, it is particularly preferable that the half-width of the light emission intensity of the blue light is less than or equal to 25 nm.

The backlight unit includes at least the light source along with the wavelength conversion member described above. In an aspect, a light source emitting blue light which has a light emission center wavelength in a wavelength range of 430 nm to 480 nm (a blue light source), for example, a blue light emitting diode emitting blue light can be used as the light source. In a case where the light source emitting blue light is used, it is preferable that at least the quantum dot (A) which is excited by exciting light and emits red light and the quantum dot (B) which emits green light are contained in the wavelength conversion layer. Accordingly, it is possible to realize white light by the blue light which is emitted from the light source and is transmitted through the wavelength conversion member, and the red light and the green light emitted from the wavelength conversion member.

In addition, in another aspect, a light source emitting ultraviolet light which has a light emission center wavelength in a wavelength range of 300 nm to 430 nm (an ultraviolet light source), for example, an ultraviolet ray light emission diode can be used as the light source. In this case, it is preferable that the quantum dot (C) which is excited by exciting light and emits blue light is contained in the wavelength conversion layer, along with the quantum dots (A) and (B). Accordingly, it is possible to realize white light by the red light, the green light, and the blue light which are emitted from the wavelength conversion member.

In addition, in another aspect, the light emitting diode can be substituted with a laser light source.

(Configuration of Backlight Unit)

For example, the backlight unit can be an edge light mode backlight unit including a light guide plate, a reflection plate, and the like as a constituent. In FIGS. 1A and 1B, an example of an edge light mode backlight unit is illustrated. A known light guide plate can be used as the light guide plate without any limitation. Here, the backlight unit may be a direct backlight mode backlight unit.

In addition, the backlight unit can include a reflection member in the rear portion of the light source. Such a reflection member is not particularly limited, and known reflection members described in JP3416302B, JP3363565B, JP4091978B, JP3448626B, and the like can be used, and the contents of the publications are incorporated in the present invention.

It is also preferable that the backlight unit further includes a known diffusion plate or a known diffusion sheet, a known prism sheet (for example, BEF series manufactured by Sumitomo 3M Limited, and the like), and a known light guide device. Such other members are described in the publications of JP3416302B, JP3363565B, JP4091978B, JP3448626B, and the like, and the contents of the publications are incorporated in the present invention.

[Liquid Crystal Display Device]

The backlight unit described above can be applied to a liquid crystal display device. The liquid crystal display device may have a configuration including at least the backlight unit described above and a liquid crystal cell.

(Configuration of Liquid Crystal Display Device)

A driving mode of the liquid crystal cell is not particularly limited, and various modes such as a twisted nematic (TN) mode, a super twisted nematic (STN) mode, a vertical alignment (VA) mode, an in-plane switching (IPS) mode, and an optically compensated bend cell (OCB) mode can be used. It is preferable that the liquid crystal cell in the VA mode, in the OCB mode, in the IPS mode, or in the TN mode, but the mode of the liquid crystal cell is not limited thereto. Examples of the configuration of the liquid crystal display device in the VA mode include a configuration illustrated in FIG. 2 of JP2008-262161A. Here, a specific configuration of the liquid crystal display device is not particularly limited, and a known configuration can be adopted.

In an embodiment of the liquid crystal display device, the liquid crystal display device includes a liquid crystal cell sandwiching a liquid crystal layer between two facing substrates of which at least one base material includes an electrode, and the liquid crystal cell is configured by being disposed between two polarizing plates. The liquid crystal display device includes the liquid crystal cell in which liquid crystals are sealed between the upper and lower substrates, and an alignment state of the liquid crystals is changed by applying a voltage, and thus, an image is displayed. Further, as necessary, the liquid crystal display device includes a subsidiary functional layer such as a polarizing plate protective film or an optical compensation member performing optical compensation, and an adhesive layer. In addition, a surface layer such as a forward scattering layer, a primer layer, an antistatic layer, and an undercoat layer may be disposed along with (or instead of) a color filter substrate, a thin layer transistor substrate, a lens film, a diffusion sheet, a hard coat layer, an antireflection layer, a low reflective layer, an antiglare layer, and the like.

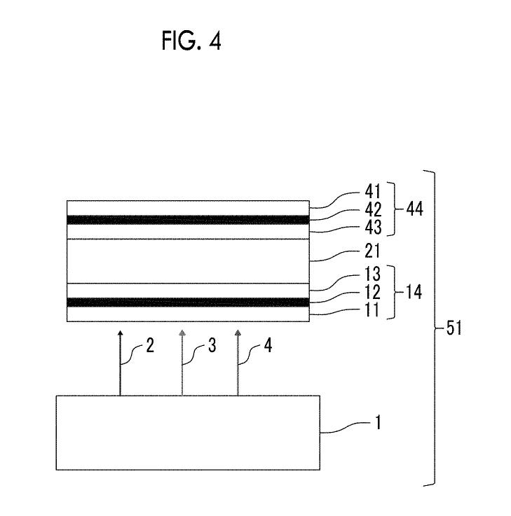

FIG. 4 illustrates an example of a liquid crystal display device according to an aspect of the present invention. A liquid crystal display device 51 illustrated in FIG. 4 includes a backlight side polarizing plate 14 on a surface of a liquid crystal cell 21 on a backlight side. The backlight side polarizing plate 14 may or may not include a polarizing plate protective film 11 on a surface of a backlight side polarizer 12 on the backlight side, and it is preferable that the backlight side polarizing plate 14 includes the polarizing plate protective film 11.

It is preferable that the backlight side polarizing plate 14 has a configuration in which the polarizer 12 is sandwiched between two polarizing plate protective films 11 and 13.

In this specification, a polarizing plate protective film on a side close to the liquid crystal cell with respect to the polarizer will be referred to as an inner side polarizing plate protective film, and a polarizing plate protective film on a side separated from the liquid crystal cell with respect to the polarizer will be referred to as an outer side polarizing plate protective film. In the example illustrated in FIG. 4, the polarizing plate protective film 13 is the inner side polarizing plate protective film, and the polarizing plate protective film 11 is the outer side polarizing plate protective film.

The backlight side polarizing plate may include a phase difference film as the inner side polarizing plate protective film on the liquid crystal cell side. A known cellulose acylate film or the like can be used as the phase difference film.

The liquid crystal display device 51 includes a display side polarizing plate 44 on the surface of the liquid crystal cell 21 on a side opposite to the surface on the backlight side. The display side polarizing plate 44 has a configuration in which a polarizer 42 is sandwiched between two polarizing plate protective films 41 and 43. The polarizing plate protective film 43 is the inner side polarizing plate protective film, and the polarizing plate protective film 41 is the outer side polarizing plate protective film.

The backlight unit 1 included in the liquid crystal display device 51 is as described above.

The liquid crystal cell, the polarizing plate, the polarizing plate protective film, and the like which configure the liquid crystal display device are not particularly limited, and constituents prepared by a known method or commercially available products can be used without any limitation. In addition, it is obviously possible to dispose a known interlayer such as an adhesive layer between the respective layers.

### EXAMPLES

Hereinafter, the present invention will be described in more detail on the basis of the following examples. Materials, use amounts, ratios, treatment contents, treatment sequences, and the like of the following examples can be suitably changed unless the changes cause deviance from the gist of the present invention. Therefore, the range of the present invention will not be restrictively interpreted by the following specific examples.

(Preparation of Barrier Film 10)

A polyethylene terephthalate film (a PET film, Product Name: COSMOSHINE (Registered Trademark) A4300 manufactured by TOYOBO CO., LTD., a thickness of 50 μm) was used as a support film, and an organic layer and an inorganic layer were sequentially formed on one surface side of the support film in the following procedure.

Trimethylol propane triacrylate (TMPTA manufactured by DAICEL-ALLNEX LTD.) and a photopolymerization initiator (ESACURE KTO46 manufactured by Lamberti S.p.A.) were prepared, were weighed to have a mass ratio of 95:5, and were dissolved in methyl ethyl ketone, and thus, a coating liquid having a concentration of solid contents of 15% was obtained. The coating liquid was applied onto the PET film described above in a roll-to-roll manner by using a die coater, and passed through a drying zone at an atmosphere temperature of 50° C. for 3 minutes. After that, the coating liquid was irradiated with an ultraviolet ray (integrated irradiation dose of approximately 600 mJ/cm²) under a nitrogen atmosphere, was cured by ultraviolet ray curing, and was wound. A thickness of a first organic layer formed on the support film was 1 μm.

Next, the inorganic layer (a silicon nitride layer) was formed on the surface of the organic layer described above by using a roll-to-roll type chemical vapor deposition (CVD) device. Silane gas (a flow rate of 160 sccm), ammonia gas (a flow rate of 370 sccm), hydrogen gas (a flow rate of 590 sccm), and nitrogen gas (a flow rate of 240 sccm) were used as raw material gas. High frequency power having a frequency of 13.56 MHz was used as power. A film formation pressure was 40 Pa, and an arrival thickness was 50 nm.

Thus, a barrier film 10 was prepared in which the inorganic layer was laminated on the surface of the first organic layer which was formed on the support film.

(Preparation of Barrier Film 11)

A silane coupling agent-containing composition having compositions described below was prepared, and was used as a composition for a surface treatment (a coating liquid for a surface treatment). The composition for a surface treatment (the coating liquid for a surface treatment) was applied onto the inorganic layer of the barrier film 10 at a coating amount of 2 ml/m² in a roll-to-roll manner by using a die coater, and passed through a drying zone at an atmosphere temperature of 120° C. for 3 minutes. Thus, a barrier film 11 was prepared in which the surface of the inorganic layer was subjected to a surface treatment by a silane coupling agent.

Composition for Surface Treatment

Isopropanol/Ethanol/Acetic Acid/Water/(KBM-5103 manufactured by Shin-Etsu Chemical Co., Ltd. (Silane Coupling Agent-Containing Solution)=14/14/2/20/50 (Mass Ratio)

### Preparation of Quantum Dot-Containing Polymerizable Composition Used in Example 1

A quantum dot-containing polymerizable composition 1 described below was prepared, was filtered through a polypropylene filter having a pore diameter of 0.2 μm, and then, was dried for 30 minutes under reduced pressure, and thus, was used as a coating liquid.

Quantum Dot-Containing Polymerizable Composition 1
(Used in Example 1)

| | | |
|---|---|---|
| Toluene Dispersion Liquid of Quantum Dot 1 | 10 | parts by mass |
| (Maximum Light Emission: 530 nm) | | |
| Quantum Dot 1: INP530-10 manufactured by | | |
| Nanomaterials and Nanofabrication Laboratories | | |
| Toluene Dispersion Liquid of Quantum Dot 2 | 1 | part by mass |
| (Maximum Light Emission: 620 nm) | | |
| Quantum Dot 2: INP620-10 manufactured by | | |
| Nanomaterials and Nanofabrication Laboratories | | |
| First Polymerizable Compound | 100 | parts by mass |
| 2-Phenoxy Ethyl Acrylate (AMP-10G | | |
| manufactured by Shin Nakamura Chemical Co., | | |
| Ltd.) | | |
| Photopolymerization Initiator | 1 | part by mass |
| (IRGACURE (Registered Trademark) 819 | | |
| manufactured by BASF SE) | | |
| Viscosity Adjuster | 10 | parts by mass |
| (FUMED SILICA AEROSIL (Registered | | |
| Trademark) R812 manufactured by | | |
| NIPPON AEROSIL CO., LTD.) | | |

(in the above description, the concentration of the quantum dots in the toluene dispersion liquids of the quantum dots 1 and 2 is 1 mass %)

### Preparation of Quantum Dot-Containing Polymerizable Composition Used in Other Examples and Comparative Examples

A quantum dot-containing polymerizable composition was prepared at a compositional ratio (a mass ratio) shown in Table 1, was filtered through a polypropylene filter having a pore diameter of 0.2 μm, and then, was dried for 30 minutes under reduced pressure, and thus, was used as a coating liquid.

### Preparation of Wavelength Conversion Member of Example 1

The barrier film 10 prepared in the sequence described above was used as a first film and a second film, and a wavelength conversion member was obtained according to the manufacturing step described with reference to FIG. 2 and FIG. 3. Specifically, the barrier film 10 was prepared as the first film, the quantum dot-containing polymerizable composition 1 prepared as described above was applied onto the surface of the inorganic layer by a die coater while continuously handling the barrier film 10 at a speed of 1 m/minute and a tensile force of 60 N/m, and thus, a coated film having a thickness of 50 μm was formed. Subsequently, the first film (the barrier film 10) on which the coated film was formed was wound around a backup roller, the second film (the barrier film 10) was laminated on the coated film in a direction where the surface of the inorganic layer was in contact with the coated film, and the quantum dot-containing polymerizable composition 1 was cured by being irradiated with an ultraviolet ray by using an air-cooled metal halide lamp (manufactured by EYE GRAPHICS CO., LTD.) of 160 W/cm while continuously handling the barrier film 10 in a state where the coated film was sandwiched between two harrier films 10, and thus, a wavelength conversion layer containing a quantum dot was formed. Irradiation dose of the ultraviolet ray was 2,000 mJ/cm².

### Preparation of Wavelength Conversion Members of Examples 1 to 16 and Comparative Examples 1 to 5

A wavelength conversion member was prepared by the same method as that in Example 1, by using the quantum dot-containing polymerizable composition (the coating liquid) which was prepared as described above and was used in each of the examples and the comparative examples, and by using the barrier film (the barrier film 10 or 11) shown in Table 1.

(Evaluation of Decrease in Backlight Brightness)

The wavelength conversion member of each of the examples and the comparative examples was punched by a punching machine using a THOMSON blade of 4 cm×4 cm. In the punched wavelength conversion member, a decrease in a backlight brightness in an outer circumferential region on an exiting surface of the backlight was evaluated by a method described below. In the wavelength conversion members of the examples and the comparative examples, the barrier film was disposed on each of both surfaces of the wavelength conversion layer as described above, but the barrier film did not exist on an end surface after punching. In a case where a decrease in a light emission efficiency of the quantum dot due to oxygen molecules entering the wavelength conversion layer from the end surface is suppressed, it is considered that a decrease in the backlight brightness in the outer circumferential region on the exiting surface of the backlight which is evaluated by a method described below is suppressed.

—Evaluation Method—

The wavelength conversion members punched as described above were arranged on a commercially available blue light source (OPSM-14150X142B manufactured by OPTEX FA CO., LTD.) in a chamber retained at a temperature of 25° C. and relative humidity of 60%, and the wavelength conversion members continuously irradiated with blue light for 100 hours.

Next, a commercially available tablet terminal (Kindle (Registered Trademark) Fire HDX 7″ manufactured by Amazon.com, Inc.) was disassembled, a backlight unit was taken out, and the wavelength conversion member which had been continuously irradiated with the blue light for 100 hours was disposed on a light guide plate, and two prism sheets taken from Kindle Fire HDX 7″ were superimposed thereon such that directions of surface unevenness patterns were orthogonal to each other. The backlight unit was turned on, and a brightness was measured by IMAGING COLORIMETERS AND PHOTOMETERS (manufactured by Prolinx Corporation) which was disposed at a distance of 740 mm from the surface (an exiting surface) of the backlight unit. From the measurement result, in the outer circumferential region on the exiting surface (a region from ends of four sides of a screen 4 to 1 cm on an inner side), a proportion of a region in which a brightness decreased from a brightness measured in the center portion on the exiting surface by greater than or equal to 15% was obtained, and was evaluated according to the following evaluation standards. The results are shown in Table 1 described below.

(Evaluation Standard)

A: The proportion of the region in which the brightness decreased by greater than or equal to 15% was less than 25% of the outer circumferential region.

B: The proportion of the region in which the brightness decreased by greater than or equal to 15% was greater than or equal to 25% and less than 50% of the outer circumferential region.

C: The proportion of the region in which the brightness decreased by greater than or equal to 15% was greater than or equal to 50% and less than 75% of the outer circumferential region.

D: The proportion of the region in which the brightness decreased by greater than or equal to 15% was greater than or equal to 75% of the outer circumferential region.

(Evaluation of Display Unevenness)

A commercially available tablet terminal (Kindle Fire HDX 7″ manufactured by Amazon.com, Inc.) was disassembled, a quantum dot film (QDEF manufactured by 3M Company) was taken out from a backlight unit, and the wavelength conversion member of each of the examples and the comparative examples which was cut out into the shape of a rectangle was incorporated instead of QDEF. Thus, a liquid crystal display device was prepared.

The prepared liquid crystal display device was turned on such that the entire surface was in white display, and display unevenness (tint unevenness and brightness unevenness) was visually observed. The display unevenness was evaluated according to the following standards. The results are shown in Table 1 described below.

(Evaluation Standard)

A: The tint unevenness and the brightness unevenness were not visible over the entire surface of the screen.

B: Any one or both of the tint unevenness and the brightness unevenness were slightly visible in a part of the screen.

C: Any one or both of the tint unevenness and the brightness unevenness were clearly visible in a part of the screen.

D: Any one or both of the tint unevenness and the brightness unevenness were visible over the entire surface of the screen.

(Evaluation of Heat Resistance)

A commercially available tablet terminal (Kindle Fire HDX 7″ manufactured by Amazon.com. Inc.) was disassembled, a quantum dot film (QDEF manufactured by 3M Company) was taken out from a backlight unit, and the wavelength conversion member of each of the examples and the comparative examples which was cut out into the shape of a rectangle was incorporated instead of QDEF. Thus, a liquid crystal display device was prepared.

The prepared liquid crystal display device was turned on such that the entire surface was in white display, and a brightness (a backlight brightness before heating) was measured by a brightness meter (Product Name “SR3”, manufactured by TOPCON CORPORATION) disposed in a position of 520 mm in a vertical direction with respect to the surface of the light guide plate.

The wavelength conversion member of each of the examples and the comparative examples which was separately prepared, a fine constant-temperature device DF411 manufactured by Yamato Scientific Co., Ltd. was used, and the wavelength conversion member was heated in the fine constant-temperature device described above of which an internal temperature was retained at 85° C. for 1000 hours. After that, as described above, the wavelength conversion member was incorporated in a commercially available liquid crystal display device, and a backlight brightness after heating was measured.

From the backlight brightnesses before and after heating, heat resistance was evaluated on the basis of the following evaluation standards. The results are shown in Table 1.

(Evaluation Standard)

A: The decrease in the backlight brightness after heating was less than 15% compared to the backlight brightness before heating

B: The decrease in the backlight brightness after heating was greater than or equal to 15% and less than 30% compared to the backlight brightness before heating

C: The decrease in the backlight brightness after heating was greater than or equal to 30% and less than 50% compared to the backlight brightness before heating

D: The decrease in the backlight brightness after heating was greater than or equal to 50% compared to the backlight brightness before heating

The results described above are shown in Table 1. Furthermore, the unit of the amount shown in Table 1 is parts by mass.

TABLE 1

| | | Film | | | | | | | | | | | | | | |
|---|---|---|---|---|---|---|---|---|---|---|---|---|---|---|---|---|
| | | Thickness | | | | | | | | | | | | | | |
| | | of | Toluene | Toluene | | | | | | | | | | | | |
| | | Wavelength | Dispersion | Dispersion | | | | | | | | | | | | |
| | | Conversion | Liquid of | Liquid of | | | | | | | | | | | | |
| | Base | Layer (μm) | Quantum | Quantum | | | | | | | | | | | | |
| | material | Film | Dot 1 | Dot 2 | First Polymerizable Compound | | | | | | | | | | | |
| | Film | Thickness | Amount | Amount | Material | Amount | Mw | F | Mw/F | LogP | Material | | Amount | | Mw/F | LogP |
| Example 1 | Barrier | 50 | 10 | 1 | AMP-10G | 100 | 192 | 1 | 192 | 2.3 | | | | | | |
| | Film 10 | | | | | | | | | | | | | | | |
| Example 2 | Barrier | 50 | 10 | 1 | AMP-10G | 60 | 192 | 1 | 192 | 2.2 | 4HBA | | 20 | | 144 | 0.7 |
| | Film 10 | | | | | | | | | | | | | | | |
| Example 3 | Barrier | 50 | 10 | 1 | AMP-10G | 75 | 192 | 1 | 192 | 2.3 | | | | | | |
| | Film 10 | | | | | | | | | | | | | | | |
| Example 4 | Barrier | 50 | 10 | 1 | AMP-10G | 80 | 192 | 1 | 192 | 2.2 | | | | | | |
| | Film 10 | | | | | | | | | | | | | | | |
| Example 5 | Barrier | 50 | 10 | 1 | AMP-10G | 70 | 192 | 1 | 192 | 2.2 | | | | | | |
| | Film 10 | | | | | | | | | | | | | | | |
| Example 6 | Barrier | 50 | 10 | 1 | BZA | 90 | 162 | 1 | 162 | 2.4 | | | | | | |
| | Film 10 | | | | | | | | | | | | | | | |
| Example 7 | Barrier | 50 | 10 | 1 | BZA | 80 | 162 | 1 | 162 | 2.4 | 4HBA | | 20 | | 144 | 0.7 |
| | Film 10 | | | | | | | | | | | | | | | |
| Example 8 | Barrier | 50 | 10 | 1 | 4HBA | 90 | 144 | 1 | 144 | 0.7 | | | | | | |
| | Film 10 | | | | | | | | | | | | | | | |
| Example 9 | Barrier | 50 | 10 | 1 | AMP-10G | 100 | 192 | 1 | 192 | 2.3 | | | | | | |
| | Film 11 | | | | | | | | | | | | | | | |
| Example 10 | Barrier | 50 | 10 | 1 | BZA | 65 | 162 | 1 | 162 | 2.4 | | | | | | |
| | Film 10 | | | | | | | | | | | | | | | |
| Example 11 | Barrier | 50 | 10 | 1 | BZA | 85 | 162 | 1 | 162 | 2.4 | | | | | | |
| | Film 10 | | | | | | | | | | | | | | | |
| Example 12 | Barrier | 50 | 10 | 1 | BZA | 85 | 162 | 1 | 162 | 2.4 | | | | | | |
| | Film 10 | | | | | | | | | | | | | | | |
| Example 13 | Barrier | 50 | 10 | 1 | BZA | 85 | 162 | 1 | 162 | 2.4 | | | | | | |
| | Film 10 | | | | | | | | | | | | | | | |
| Example 14 | Barrier | 50 | 10 | 1 | BZA | 65 | 162 | 1 | 162 | 2.4 | | | | | | |
| | Film 10 | | | | | | | | | | | | | | | |
| Example 15 | Barrier | 50 | 10 | 1 | AMP-10G | 70 | 192 | 1 | 192 | 2.2 | | | | | | |
| | Film 10 | | | | | | | | | | | | | | | |
| Example 16 | Barrier | 50 | 10 | 1 | AMP-10G | 70 | 192 | 1 | 192 | 2.2 | | | | | | |
| | Film 10 | | | | | | | | | | | | | | | |
| Comparative | Barrier | 50 | 10 | 1 | | | | | | | | | | | | |
| Example 1 | Film 10 | | | | | | | | | | | | | | | |
| Comparative | Barrier | 50 | 10 | 1 | | | | | | | | | | | | |
| Example 2 | Film 10 | | | | | | | | | | | | | | | |
| Comparative | Barrier | 50 | 10 | 1 | AMP-10G | 45 | 192 | 1 | 192 | 2.3 | | | | | | |
| Example 3 | Film 10 | | | | | | | | | | | | | | | |
| Comparative | Barrier | 50 | 10 | 1 | | | | | | | | | | | | |
| Example 4 | Film 10 | | | | | | | | | | | | | | | |
| Comparative | Barrier | 50 | 10 | 1 | | | | | | | | | | | | |
| Example 5 | Film 10 | | | | | | | | | | | | | | | |
| | Second Polymerizable Compound | | | | | | | | | | Other Polymerizable Compound | | | | | |
| | Material | Amount | Mw | F | Mw/F | LogP | Material | Amount | Mw/F | LogP | Material | Amount | Mw | F | Mw/F | LogP |
| Example 1 | | | | | | | | | | | | | | | | |
| Example 2 | | | | | | | | | | | | | | | | |
| Example 3 | CEL2021P | 25 | 252 | 2 | 126 | 0.8 | | | | | | | | | | |
| Example 4 | CYCLOMER | 20 | 196 | 2 | 98 | 1.4 | | | | | | | | | | |
| | M100 | | | | | | | | | | | | | | | |
| Example 5 | CYCLOMER | 15 | 196 | 2 | 98 | 1.4 | CEL2021P | 15 | 126 | 0.8 | | | | | | |
| | M100 | | | | | | | | | | | | | | | |
| Example 6 | TMPTA | 10 | 297 | 3 | 99 | 2.5 | | | | | | | | | | |
| Example 7 | | | | | | | | | | | | | | | | |
| Example 8 | TMPTA | 10 | 297 | 3 | 99 | 2.5 | | | | | | | | | | |
| Example 9 | | | | | | | | | | | | | | | | |
| Example 10 | A-TMMT | 15 | 352 | 4 | 88 | 2.0 | | | | | | | | | | |
| Example 11 | A-DPH | 15 | 578 | 6 | 98 | 2.7 | | | | | | | | | | |
| Example 12 | A-DCP | 15 | 304 | 2 | 152 | 3.1 | | | | | | | | | | |
| Example 13 | 1,9NDA | 15 | 268 | 2 | 134 | 3.7 | | | | | IB-X | 10 | 222 | 1 | 222 | 3.7 |
| Example 14 | TMPTA | 5 | 297 | 3 | 99 | 2.5 | | | | | | | | | | |
| Example 15 | CYCLOMER | 15 | 196 | 2 | 98 | 1.4 | CEL2021P | 15 | 126 | 0.8 | | | | | | |
| | M100 | | | | | | | | | | | | | | | |
| Example 16 | CYCLOMER | 15 | 196 | 2 | 98 | 1.4 | CEL2021P | 15 | 126 | 0.8 | | | | | | |
| | M100 | | | | | | | | | | | | | | | |
| Comparative | | | | | | | | | | | LA | 100 | 240 | 1 | 240 | 5.2 |
| Example 1 | | | | | | | | | | | | | | | | |
| Comparative | | | | | | | | | | | MMA | 100 | 100 | 1 | 100 | 1.0 |
| Example 2 | | | | | | | | | | | | | | | | |
| Comparative | TMPTA | 55 | 297 | 3 | 99 | 2.5 | | | | | | | | | | |
| Example 3 | | | | | | | | | | | | | | | | |
| Comparative | Glycidyl | 65 | 142 | 2 | 71 | 0.6 | TMPTA | 35 | 99 | 2.5 | | | | | | |
| Example 4 | Methacrylate | | | | | | | | | | | | | | | |
| Comparative | TMPTA | 100 | 297 | 3 | 99 | 2.5 | | | | | | | | | | |
| Example 5 | | | | | | | | | | | | | | | | |

| | | | | | | | | Decrease | |
|---|---|---|---|---|---|---|---|---|---|
| | | | | | | | | in | |
| | | | | | | | Display | Backlight | Heat |
| | | | | | | | Unevenness | Brightness | Resistance |
| | Polymerization Initiator | | | | Viscosity Adjuster | | Evaluation | Evaluation | Evaluation |
| | Material | Amount | Material | Amount | Material | Amount | Result | Result | Result |
| Example 1 | IRGACURE | 1 | | | AEROSIL | 10 | A | B | B |
| | 819 | | | | R812 | | | | |
| Example 2 | IRGACURE | 1 | | | AEROSIL | 10 | A | A | B |
| | 819 | | | | R812 | | | | |
| Example 3 | IRGACURE | 1 | IRGACURE | 0.7 | AEROSIL | 10 | A | A | A |
| | 819 | | 290 | | R812 | | | | |
| Example 4 | IRGACURE | 1 | IRGACURE | 0.8 | AEROSIL | 10 | A | A | A |
| | 819 | | 290 | | R812 | | | | |
| Example 5 | IRGACURE | 1 | IRGACURE | 0.9 | AEROSIL | 10 | A | A | A |
| | 819 | | 290 | | R812 | | | | |
| Example 6 | IRGACURE | 1 | | | AEROSIL | 10 | B | B | A |
| | 819 | | | | R812 | | | | |
| Example 7 | IRGACURE | 1 | | | AEROSIL | 10 | A | B | B |
| | 819 | | | | R812 | | | | |
| Example 8 | IRGACURE | 1 | | | AEROSIL | 10 | A | B | A |
| | 819 | | | | R812 | | | | |
| Example 9 | IRGACURE | 1 | | | AEROSIL | 10 | A | A | B |
| | 819 | | | | R812 | | | | |
| Example 10 | IRGACURE | 1 | | | AEROSIL | 10 | B | B | A |
| | 819 | | | | R812 | | | | |
| Example 11 | IRGACURE | 1 | | | AEROSIL | 10 | B | B | A |
| | 819 | | | | R812 | | | | |
| Example 12 | IRGACURE | 1 | | | AEROSIL | 10 | A | B | A |
| | 819 | | | | R812 | | | | |
| Example 13 | IRGACURE | 1 | | | AEROSIL | 10 | A | B | A |
| | 819 | | | | R812 | | | | |
| Example 14 | IRGACURE | 1 | | | AEROSIL | 10 | A | B | A |
| | 819 | | | | R812 | | | | |
| Example 15 | IRGACURE | 1 | Photocationic | 0.6 | AEROSIL | 10 | A | A | A |
| | 819 | | Polymerization | | R812 | | | | |
| | | | Initiator A | | | | | | |
| Example 16 | IRGACURE | 1 | Photocationic | 0.9 | AEROSIL | 10 | A | A | A |
| | 819 | | Polymerization | | R812 | | | | |
| | | | Initiator C | | | | | | |
| Comparative | IRGACURE | 1 | | | AEROSIL | 10 | A | D | D |
| Example 1 | 819 | | | | R812 | | | | |
| Comparative | IRGACURE | 1 | | | AEROSIL | 10 | C | C | C |
| Example 2 | 819 | | | | R812 | | | | |
| Comparative | IRGACURE | 1 | | | AEROSIL | 10 | C | B | A |
| Example 3 | 819 | | | | R812 | | | | |
| Comparative | IRGACURE | 1 | IRGACURE | 1.9 | AEROSIL | 10 | C | C | A |
| Example 4 | 819 | | 290 | | R812 | | | | |
| Comparative | IRGACURE | 1 | | | AEROSIL | 10 | D | D | A |
| Example 5 | 819 | | | | R812 | | | | |

AMP-10G: 2-Phenoxy Ethyl Acrylate (manufactured by Shin Nakamura Chemical Co., Ltd.)
4HBA: 4-Hydroxy Butyl Acrylate (manufactured by Nippon Kasei Chemical Co., Ltd.)
BZA: Benzyl Acrylate (manufactured by Osaka Organic Chemical Industry, Ltd.)
CEL2021P: CELLOXIDE 2021P (manufactured by Daicel Corporation)
CYCLOMER M100: 3,4-Epoxy Cyclohexyl Methyl Methacrylate (manufactured by Daicel Corporation)
TMPTA: Trifunctional Acrylate (manufactured by DAICEL-ALLNEX LTD.)
LA: Lauryl Acrylate (manufactured by Osaka Organic Chemical Industry, Ltd.)
MMA: Methacrylic Acid Methyl (manufactured by Mitsubishi Gas Chemical Company, Inc.)
A-TMMT: Pentaerythritol Tetraacrylate (manufactured by Shin Nakamura Chemical Co., Ltd.)
A-DPH: Dipentaerythritol hexaacrylate (manufactured by Shin Nakamura Chemical Co., Ltd.)
A-DCP: Tricyclodecane Dimethanol Diacrylate (manufactured by Shin Nakamura Chemical Co., Ltd.)
1,9-NDA: 1,9-Nonane Diol Diacrylate (manufactured by KYOEISHA CHEMICAL Co., LTD.)
IB-X: Isobornyl Methacrylate (manufactured by KYOEISHA CHEMICAL Co., LTD.)
IRGACURE 519: Photopolymerization initiator (manufactured by BASF SE)
IRGACURE 290: Photocationic Polymerization Initiator Irgacure PAG 290 (manufactured by BASF SE)
AEROSIL R812: Fumed Silica (manufactured by NIPPON AEROSIL CO., LTD.)
Photocationic Polymerization Initiator A: Iodonium Salt Compound described above
Photocationic Polymerization Initiator C: Iodoniurn Salt Compound described above

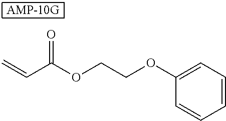

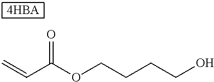

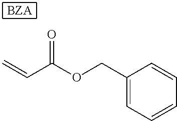

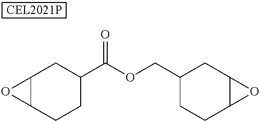 [SMILES: O=C(OCC1CCC2OC2C1)C1CCC2OC2C1]

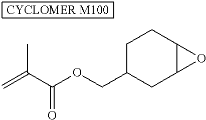

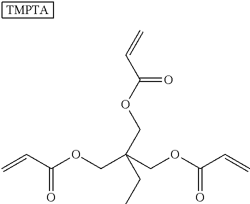

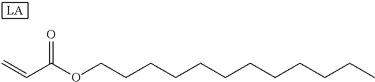 [SMILES: C=CC(=O)OCCCCCCCCCCCC]

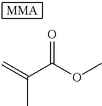

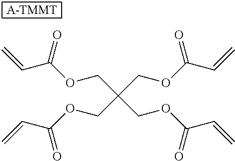

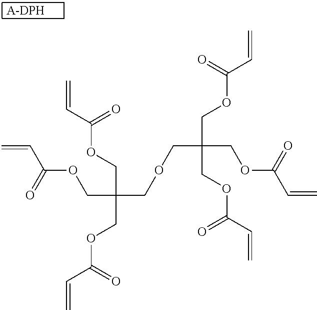 [SMILES: C=CC(=O)OCC(COCC(COC(=O)C=C)(COC(=O)C=C)COC(=O)C=C)(COC(=O)C=C)COC(=O)C=C]

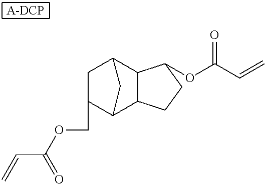 [SMILES: C=CC(=O)OCC1CC2CC1C1CCC(OC(=O)C=C)C21]

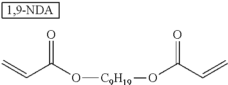

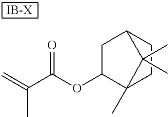 [SMILES: C=C(C)C(=O)OC1CC2CCC1(C)C2(C)C]

From the results shown in Table 1, in the backlight unit provided with the wavelength conversion member of each of the examples, it is possible to confirm that a decrease in the backlight brightness is suppressed, and the display unevenness on a display surface of the liquid crystal display device including the backlight unit provided with the wavelength conversion member of each of the examples is suppressed.

Further, it is possible to confirm that the wavelength conversion members of the examples which contain the second polymerizable compound (the polymerizable compound in which the number of polymerizable functional groups in one molecule is greater than or equal to 2) have excellent heat resistance compared to a wavelength conversion member of other examples. Furthermore, test conditions of the evaluation of the heat resistance described above are acceleration test conditions, and in a case where the evaluation result of the heat resistance is greater than or equal to B, it is indicated that the heat resistance is practically sufficient, and in a case where the evaluation result of the heat resistance is A, it is indicated that the heat resistance extremely excellent.

(Evaluation of End Portion After Punching)

The wavelength conversion member of each of the examples was put into a constant-temperature tank at 80° C. for 24 hours, and then, humidity adjustment was performed for 1 hour in a room at a temperature of 25° C. and relative humidity of 60%, and after that, punching was performed with respect to five wavelength conversion member samples by a punching machine using a THOMSON blade of 4 cm×4 cm.

In the punched wavelength conversion member sample of 4 cm×4 cm, the state of the end portion of each side was scored by setting a score of 4.00 per one sample as the highest score on the basis of the following standards.

Score of 0.00: Peeling off between the wavelength conversion layer and the adjacent inorganic layer or a crack on the wavelength conversion layer did not occur.

Score of 0.25: A region of the peeling off and the crack described above was less than or equal to 25% of one side.

Score of 0.50: The region of the peeling off and the crack described above was described above peeling off was greater than 25% and less than or equal to 50% of one side.

Score of 0.75: The region of the peeling off and the crack described above was described above peeling oil was greater than 50% and less than or equal to 75% of one side.

Score of 1.00: The region of the peeling off and the crack described above was described above peeling off was greater than 75% of one side.

In the five wavelength conversion member samples, the total score was calculated, evaluation was performed as described below; and the results were shown in Table 2 described below.

D: The score of 0.00

C: The score of greater than 0.00 and less than 5.00

B: The score of greater than or equal to 5.00 and less than 10.00

A: The score of greater than or equal to 10.00 and less than 15.00

AA: The score from 15.00 to 20.00

In the evaluation described above, the wavelength conversion member having an evaluation result of AA, A, or B can be sufficiently used as a product, and the wavelength conversion member having an evaluation result of AA or A is more preferable, and the wavelength conversion member having an evaluation result of AA is even more preferable.

TABLE 2

| | Evaluation of End |
|---|---|
| | Portion after |
| | Punching |
| | Evaluation Result |
| Example 1 | A |
| Example 2 | A |
| Example 3 | A |
| Example 4 | A |
| Example 5 | A |
| Example 6 | B |
| Example 7 | B |
| Example 8 | B |
| Example 9 | AA |
| Example 10 | B |
| Example 11 | B |
| Example 12 | B |
| Example 13 | B |
| Example 14 | B |
| Example 15 | A |
| Example 16 | A |

### EXPLANATION OF REFERENCES

1: backlight unit

1A: light source

1B: light guide plate

100: manufacturing device

10: first film

20: coating unit

22: coated film

24: die coater

26: backup roller

28: cured layer

30: laminating unit

32: laminating roller

34: heating chamber

50: second film

60: curing unit

62: backup roller

64: ultraviolet ray irradiation device

70: laminated film

80: peeling off roller

What is claimed is:

1. A wavelength conversion member, comprising:
a wavelength conversion layer containing a quantum dot which is excited by exciting light and emits fluorescent light,
wherein the wavelength conversion layer is a cured layer formed by curing a polymerizable composition containing the quantum dot and a polymerizable compound,
the polymerizable composition contains at least one type of first polymerizable compound,
the first polymerizable compound is a monofunctional (meth)acrylate compound in which a value of Mw/F obtained by dividing a molecular weight Mw by the number F of polymerizable functional groups in one molecule is greater than or equal to 130, the number of (meth)acryloyl groups in one molecule is 1, and a Log P value is less than or equal to 3.0, and
the polymerizable composition contains greater than or equal to 50 parts by mass of the first polymerizable compound with respect to 100 parts by mass of the total amount of the polymerizable compound contained in the polymerizable composition.

2. The wavelength conversion member according to claim 1, further comprising:
a base material,
wherein at least one main surface of the wavelength conversion layer is in contact with the base material.

3. The wavelength conversion member according to claim 1, further comprising:
a first base material and a second base material,
wherein the wavelength conversion layer is in contact with the first base material on one main surface, and is in contact with the second base material on the other main surface, and
both of the first base material and the second base material have an oxygen permeability of less than or equal to 1.00 cm³/m²/day/atm.

4. The wavelength conversion member according to claim 1,
wherein the polymerizable composition contains at least one type of other polymerizable compound along with the first polymerizable compound.

5. The wavelength conversion member according to claim 4,
wherein the other polymerizable compound contains a second polymerizable compound in which the number of polymerizable functional groups in one molecule is greater than or equal to 2.

6. The wavelength conversion member according to claim 5,
wherein the second polymerizable compound is a polymerizable compound containing two or more polymerizable functional groups selected from the group consisting of a (meth)acryloyl group, a vinyl group, an epoxy group, and an oxetanyl group in one molecule.

7. The wavelength conversion member according to claim 1,
wherein the quantum dot-containing polymerizable composition further contains a viscosity adjuster.

8. The wavelength conversion member according to claim 1,
wherein the quantum dot is at least one type selected from the group consisting of a quantum dot having a light emission center wavelength in a wavelength range of 600 nm to 680 nm, a quantum dot having a light emission center wavelength in a wavelength range of 520 nm to 560 nm, and a quantum dot having a light emission center wavelength in a wavelength range of 430 nm to 480 nm.

9. A backlight unit, comprising at least:
the wavelength conversion member according to claim 1; and
a blue light source or an ultraviolet light source.

10. A liquid crystal display device, comprising at least:
the backlight unit according to claim 9; and
a liquid crystal cell.

11. A quantum dot-containing polymerizable composition, containing:
a quantum dot which is excited by exciting light and emits fluorescent light; and
a polymerizable compound,
wherein the polymerizable composition contains at least one type of first polymerizable compound,
the first polymerizable compound is a monofunctional (meth)acrylate compound in which a value of Mw/F obtained by dividing a molecular weight Mw by the number F of polymerizable functional groups in one molecule is greater than or equal to 130, the number of (meth)acryloyl groups in one molecule is 1, and a Log P value is less than or equal to 3.0, and
the polymerizable composition contains greater than or equal to 50 parts by mass of the first polymerizable compound with respect to 100 parts by mass of the total amount of the polymerizable compound contained in the polymerizable composition.

12. The quantum dot-containing polymerizable composition according to claim 11,
wherein the polymerizable composition contains at least one type of other polymerizable compound along with the first polymerizable compound.

13. The quantum dot-containing polymerizable composition according to claim 12,
wherein the other polymerizable compound contains a second polymerizable compound in which the number of polymerizable functional groups in one molecule is greater than or equal to 2.

14. The quantum dot-containing polymerizable composition according to claim 13,
wherein the second polymerizable compound is a polymerizable compound containing two or more polymerizable functional groups selected from the group consisting of a (meth)acryloyl group, a vinyl group, an epoxy group, and an oxetanyl group in one molecule.

15. The quantum dot-containing polymerizable composition according to claim 11, further containing:
a viscosity adjuster.

16. The quantum dot-containing polymerizable composition according to claim 11,
wherein the quantum dot is at least one type selected from the group consisting of a quantum dot having a light emission center wavelength in a wavelength range of 600 nm to 680 nm, a quantum dot having a light emission center wavelength in a wavelength range of 520 nm to 560 nm, and a quantum dot having a light emission center wavelength in a wavelength range of 430 nm to 480 nm.
